(19) United States
(12) Patent Application Publication
(10) Pub. No.: US 2024/0264267 A1
(43) Pub. Date: Aug. 8, 2024

(54) COMMUNICATION PROCESSING DEVICE, COMMUNICATION SYSTEM, AND COMMUNICATION PROCESSING METHOD

(71) Applicant: Sony Semiconductor Solutions Corporation, Kanagawa (JP)

(72) Inventors: Satoshi Okada, Tokyo (JP); Kenichi Fujimaki, Kanagawa (JP)

(21) Appl. No.: 18/564,998

(22) PCT Filed: Jun. 3, 2022
(86) PCT No.: PCT/JP22/22643

§ 371 Date: Nov. 28, 2023

(30) Foreign Application Priority Data
Jul. 16, 2021 (JP) 2021-117818

(51) Int. Cl. G01S 7/00; G01S 13/00; G01S 13/86; G01S 13/88

(52) U.S. Cl. CPC G01S 7/006; G01S 13/003; G01S 13/86; G01S 13/886

(57) ABSTRACT

[Problem] Provided is a communication processing device, a communication processing method, and a communication system capable of detecting when a person, an object, or the like enters a specific area, using a simple configuration.

[Solution] The communication processing device includes: a detection unit that, based on a propagation channel characteristic in a propagation channel between devices, detects a presence of a person/object in the propagation channel; and an output unit that outputs a signal including information about the detection.

### TECHNICAL FIELD

The present disclosure relates to a communication processing device, a communication system, and a communication processing method.

### BACKGROUND ART

Indoor positioning techniques have been attracting attention in recent years. However, because satellite signals cannot reach indoors, there is an issue in that Global Positioning System (GPS) and Global Navigation Satellite System (GNSS) signals cannot be received. A rangefinding method using wireless signals has therefore been proposed as an indoor positioning technique. Meanwhile, there is demand to be able to detect when a person, an object, or the like intrudes into a specific area indoors.

To detect a person, an object, or the like, however, it is necessary to deploy specialized devices such as cameras and radars separately, which increases costs. Furthermore, there is a risk that cameras cannot be employed in environments where privacy must be protected.

### CITATION LIST

### Patent Literature

[PTL 1]
JP 2007-36949A

### SUMMARY

### Technical Problem

Accordingly, the present disclosure provides a communication processing device, a communication system, and a communication processing method capable of detecting when a person, an object, or the like enters a specific area, using a simple configuration.

### Solution to Problem

To solve the above problem, according to the present disclosure, there is provided a communication processing device including: a detection unit that, based on a propagation channel characteristic in a propagation channel between devices, detects a presence of a person/object in the propagation channel; and an output unit that outputs a signal including information about the detection.

The detection unit may detect the presence of the person/object in the propagation channel based on a fluctuation in a value pertaining to the propagation channel characteristic between the devices.

The detection unit may detect the presence of the person/object in the propagation channel based on a fluctuation in a response level of a radio wave between the devices.

The communication processing device may further include: a storage unit that stores information pertaining to the response level of the radio wave in time series; and a computation processing unit that, using the information pertaining to the response level stored in the storage unit, computes a fluctuation amount in the response level at a plurality of different times, and the detection unit may detect the presence of the person/object in the propagation channel based on the fluctuation amount.

The communication processing device may further include a distance obtaining unit that obtains distance information calculated on the basis of the propagation channel characteristic.

The communication processing device may further include a positioning unit that detects a position of a target object based on the distance information.

The distance obtaining unit may obtain at least three instances of the distance information pertaining to a distance between the target object and each of at least three communication partner devices, and the positioning unit may detect the position of the target object based on the at least three instances of the distance information.

The communication processing device may further include a control unit that switches between a first mode for detecting a person/object using the detection unit and a second mode for detecting the position of the target object using the positioning unit.

The positioning unit may select distance information to be used when detecting the position of the target object based on a radio wave characteristic between the target object and each of the communication partner device.

The communication processing device may further include an image generation unit that generates an image associating the position detected by the positioning unit with information about a predetermined area.

The image generation unit may generate the image associating chronological positions detected by the positioning unit with the information about the predetermined area.

A communication unit capable of wireless communication may further be included; the target object may be a mobile terminal device capable of communication; and the control unit may cause the mobile terminal device to transmit the image through the communication unit.

The device may be at least one of a mobile communication device, a beacon device, a server, or a base station that communicates wirelessly with any of the mobile communication device and the beacon device.

The communication processing device may further include a communication unit that transmits the distance information to a processing device.

The distance obtaining unit may obtain the distance information calculated on the basis of group delay calculated from relationships between each of frequencies and phases of a plurality of propagation channels.

The distance obtaining unit may obtain the distance information based on a wireless signal in an Ultra Wide Band (UWB) band.

The detection unit may detect the presence of the person/object between the devices based on information pertaining to each of frequencies and phases of a plurality of propagation channels between the devices.

According to the present disclosure, there is provided a communication processing method including: detecting, based on a propagation channel characteristic in a propagation channel between devices, a presence of a person/object in the propagation channel; and outputting a signal including information about the detection.

According to the present disclosure, a communication system including a plurality of devices is provided, wherein at least one device among the plurality of devices includes a detection unit that, based on a propagation channel characteristic in a propagation channel between devices, detects a presence of a person/object in the propagation channel.

The at least one device among the plurality of devices may further include: a distance obtaining unit that obtains distance information calculated on the basis of the propagation channel characteristic.

The at least one device among the plurality of devices may further include: a positioning unit that detects a position of a target object based on the distance information.

Each of the plurality of devices may be at least one of a mobile communication device, a beacon device, a server, or a base station that communicates wirelessly with any of the mobile communication device and the beacon device.

The communication processing device may further include an alarm device that performs predetermined processing in response to a signal including information about the detection by the detection unit.

The alarm device may control any of a light source or a sound source in response to the signal.

The plurality of devices may be a combination of a plurality of beacon devices and a processing device.

The plurality of devices may be a combination of a plurality of mobile terminal devices and a processing device.

The plurality of devices may be a combination of a beacon device, a mobile terminal device, and a processing device.

The plurality of devices may be a combination of beacon devices.

The plurality of devices may be a combination of mobile terminal devices.

The plurality of devices may be a combination of a beacon device and a mobile terminal device.

### BRIEF DESCRIPTION OF DRAWINGS

FIG. 1 is a diagram illustrating an example of the configuration of a communication system for calculating a position of a device.

FIG. 2 is a diagram schematically illustrating an example of the deployment of the communication system of FIG. 1.

FIG. 3 is a diagram illustrating an example of the configuration of a communication system when detecting the intrusion of a person/object into a specific area.

FIG. 4 is a diagram schematically illustrating an example of the deployment of a communication system 1 illustrated in FIG. 3.

FIG. 5 is a block diagram illustrating an example of the configuration of a communication device.

FIG. 6 is a block diagram illustrating a communication device 10 according to a first embodiment in more detail than in FIG. 5.

FIG. 7 is a block diagram illustrating an example of the internal configurations of a phase-based initiator and reflector.

FIG. 8 is a block diagram illustrating an example of the internal configurations of a phase-based initiator and reflector.

FIG. 9 is a diagram illustrating an example of a signal sequence transmitted between a phase-based initiator and reflector.

FIG. 10 is a diagram illustrating a method for cancelling a local phase.

FIG. 11 is another diagram illustrating a method for cancelling a local phase.

FIG. 12 is yet another diagram illustrating a method for cancelling a local phase.

FIG. 13 is a block diagram illustrating an example of the configuration of a processing device.

FIG. 14 is a diagram illustrating an example of distance information stored in a first storage unit.

FIG. 15 is an example of an image indicating a processing result, generated by an image generation unit.

FIG. 16 is an example of an image indicating another processing result, generated by the image generation unit.

FIG. 17 is a diagram illustrating an example of a radio wave path during radio wave measurement in FIGS. 10 to 12.

FIG. 18 is a diagram illustrating an example of response characteristics of direct waves in a direct path and multipath waves in multipaths illustrated in FIG. 17.

FIG. 19 is a diagram illustrating a direct wave in a direct path and a multipath path, simulating a real environment.

FIG. 20 is a diagram illustrating an example of response characteristics of direct waves in a direct path and multipath waves in multipaths illustrated in FIG. 17.

FIG. 21 is a diagram illustrating an example of response characteristics of direct waves in a direct path and multipath waves in multipaths in a real environment.

FIG. 22 is a diagram illustrating an example of response characteristics of direct waves in a direct path and multipath waves in multipaths in a real environment different from that in FIG. 21.

FIG. 23 is a diagram illustrating an example of a multipath path where an intruder is present, simulating a real environment.

FIG. 24 is a diagram illustrating an example of response characteristics of direct waves in a direct path and multipath waves in multipaths illustrated in FIG. 23.

FIG. 25 is a diagram illustrating an example of a signal sequence transmitted between a phase-based initiator and reflector.

FIG. 26 is a diagram illustrating an example of a detection result from a detection unit.

FIG. 27 is a block diagram illustrating an example of the configuration of an alarm device.

FIG. 28 is a flowchart illustrating positioning processing operations in a processing device.

FIG. 29 is a flowchart illustrating monitoring positioning processing in a processing device.

FIG. 30 is a block diagram illustrating a case where a communication device has a positioning function and a monitoring function.

FIG. 31 is a diagram illustrating an example in which the communication device illustrated in FIG. 30 is provided as a beacon device.

FIG. 32 is a block diagram illustrating a case where a communication device has a positioning function.

FIG. 33 is a block diagram illustrating a case where a communication device has a positioning function.

FIG. 34 is a diagram illustrating an example in which the communication device illustrated in FIG. 32 is provided as a mobile communication device.

FIG. 35 is a diagram illustrating an example in which the communication device illustrated in FIG. 33 is provided as a beacon device.

FIG. 36 is a diagram illustrating an example in which a communication device is used as a mobile communication device during positioning, and a processing device is used during monitoring.

FIG. 37 is a diagram illustrating an example of a measurement signal during radio wave measurement in a communication device.

FIG. 38 is a diagram illustrating an example of a signal sequence transmitted between a pulse measurement-based initiator and reflector in distance measurement.

FIG. 39 is a diagram illustrating an example of a signal sequence transmitted between a pulse measurement-based initiator and reflector in monitoring processing.

FIG. 40 is a diagram illustrating an example of the configuration of a communication system when detecting an intrusion according to a second embodiment.

FIG. 41 is a diagram schematically illustrating an example of the deployment of the communication system illustrated in FIG. 40.

FIG. 42 is a diagram illustrating another example of the configuration of a communication system when detecting an intrusion according to the second embodiment.

FIG. 43 is a diagram illustrating an example of the configuration of a communication system according to a third embodiment.

FIG. 44 is a diagram illustrating an example of the configuration of a communication system according to a fourth embodiment.

FIG. 45 is a table illustrating an example in which information from a computation processing unit is stored in a first storage unit in association with a device.

FIG. 46 is a diagram illustrating another example of the configuration of a communication system according to the fourth embodiment.

FIG. 47 is a diagram illustrating yet another example of the configuration of a communication system according to the fourth embodiment.

FIG. 48 is a diagram illustrating an example in which the communication device of FIG. 47 is configured as a mobile terminal device.

FIG. 49 is a diagram illustrating an example of the configuration of a communication system according to a fifth embodiment.

FIG. 50 is a diagram illustrating an example of the arrangement of a device c, which is a beacon device, and a device 1, which is a mobile terminal device.

FIG. 51 is a diagram illustrating another example of the configuration of a communication system according to the fifth embodiment.

FIG. 52 is a diagram illustrating yet another example of the configuration of a communication system 1 according to the fifth embodiment.

### DESCRIPTION OF EMBODIMENTS

Embodiments of a communication processing device, a communication system, and a communication processing method will be described hereinafter with reference to the drawings. Although the following descriptions will focus on the main components of the communication device and the communication system, components or functions that are not illustrated or described may be present in the communication processing device and the communication system. The following descriptions are not intended to exclude components or functions that are not illustrated or described.

### First Embodiment

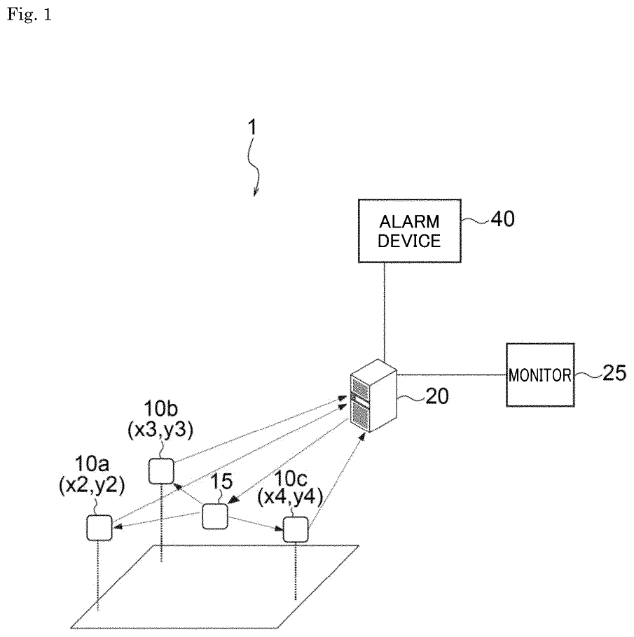

An example of the configuration of a communication system 1 according to a first embodiment will be described with reference to FIGS. 1 to 4. The communication system 1 according to the first embodiment is a system capable of calculating the position of a device 15, as well as detecting the intrusion of a person, an object, an animal, or the like into a specific area.

FIG. 1 is a diagram illustrating an example of the configuration of the communication system 1 that calculates the position of the device 15. As illustrated in FIG. 1, the communication system 1 includes a plurality of devices 10a to 10c, a processing device 20, a display device 25, and an alarm device 40.

The plurality of devices 10a to 10c are beacon devices, for example. The plurality of devices 10a to 10c can generate distance information with a communication partner device by communicating wirelessly with the communication partner device. For example, by transmitting and receiving radio waves with the device 15, the plurality of devices 10a to 10c can measure a distance to the device. In addition, when the intrusion of a person, an object, an animal, or the like into the specific area is detected, the plurality of devices 10a to 10c can measure the radio wave strength among the devices 10a to 10c.

The device 15 is a mobile communication device, such as a smartphone or a mobile phone, for example. The device 15 can communicate wirelessly in accordance with the plurality of devices 10a to 10c. The device 15 also transmits a signal including identification information.

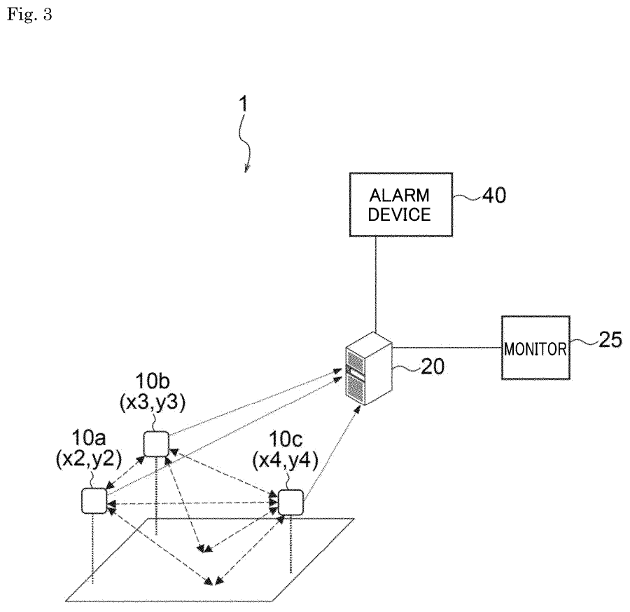

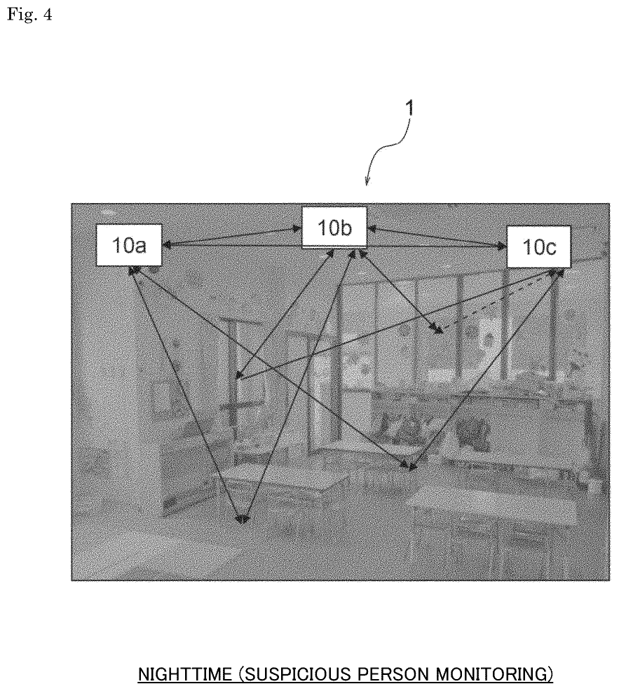

The processing device 20 is a server, for example, and uses distance information obtained from the plurality of devices 10a to 10c to the device 15 to locate the position of the device 15. The processing device 20 also detects the intrusion of a person, an object, an animal, or the like based on fluctuations in the levels of communication radio waves among the plurality of devices 10a to 10c, as will be described later with reference to FIGS. 3 and 4. The communication between the processing device 20 and the devices 10a to 10c may be wireless or wired.

The display device 25 is a monitor, for example, and displays results of processing by the processing device 20. The alarm device 40 is a device that emits an alarm when the processing device 20 detects the intrusion of a person, an object, an animal, or the like.

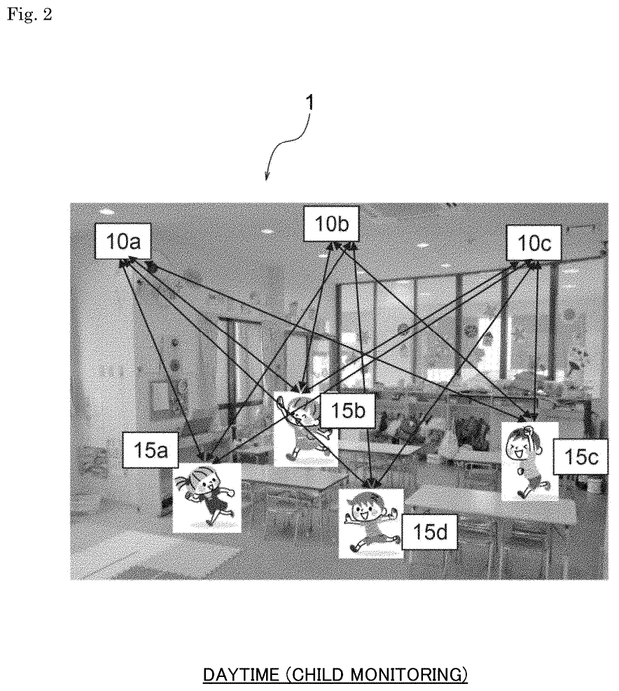

FIG. 2 is a diagram schematically illustrating an example of the deployment of the communication system 1 of FIG. 1. The positions of devices 15a to 15d are measured by the communication system 1. FIG. 2 is an example of monitoring children by measuring the positions of children carrying the devices 15a to 15d in a classroom such as at a kindergarten, for example. In this example, the processing device 20 monitors the activities and positions of the children by tracking the positions of the devices 15a to 15d. As described above, the devices 15a to 15d are transmitting signals including identification information, and the processing device 20 can therefore track the positions in association with the identification information of the devices 15a to 15d.

FIG. 3 is a diagram illustrating an example of the configuration of the communication system 1 when detecting the intrusion of a person, an object, an animal, or the like into a specific area. As illustrated in FIG. 3, when detecting a person, in the communication system 1, the processing device 20 detects the intrusion of a person, an object, an animal, or the like based on propagation channel characteristics among the devices 10a to 10c. “Propagation channel characteristics” refers to a characteristic when a wireless signal propagates through a propagation path, e.g., the strength of the communication radio waves propagating through the propagation path. For example, the processing device 20 detects the intrusion of a person, an object, an animal, or the like based on fluctuations in the levels of the communication radio waves among the devices 10a to 10c. Note that in the present embodiment, the strength of the communication radio waves will be referred to as a “response level” or simply a “level”.

In the communication system 1, when detecting the intrusion of a person, an object, an animal, or the like into a specific area, the devices 10a to 10c communicate through multipath radio waves, such as reflected waves, in addition to direct wave communication over direct paths. Information about these types of communication is supplied to the processing device 20 from the devices 10a to 10c. The processing device 20 detects the intrusion of a person, an object, an animal, or the like based on the information about the communication radio waves among the devices 10a to 10c. For example, the processing device 20 detects that a person, an object, an animal, or the like has intruded when the levels of the communication radio waves among the devices 10a to 10c fluctuate. Note that in the present embodiment, a person, an object, an animal, or the like may be referred to as a “person/object”. In addition, the detection of the intrusion of a person, an object, an animal, or the like may be referred to as “detecting a person/object”. In addition, the propagation paths of radio waves among the devices 10a to 10c, including direct paths and multipaths such as reflected waves, will be referred to as “propagation channels”. Accordingly, the range of the specific area can be set so as to include multipaths such as reflected waves.

FIG. 4 is a diagram schematically illustrating an example of the deployment of the communication system 1 illustrated in FIG. 3. This figure illustrates an example of monitoring for a suspicious person intruding into a classroom, such as in a kindergarten, at night. In this manner, with the communication system 1 according to the present embodiment, if at least two of the plurality of devices 10a to 10c are disposed when monitoring for intrusions, the intrusion of a person, an object, an animal, or the like can be detected. Hereinafter, the devices 10a to 10c and the devices 15a to 15d may be referred to as “communication devices”.

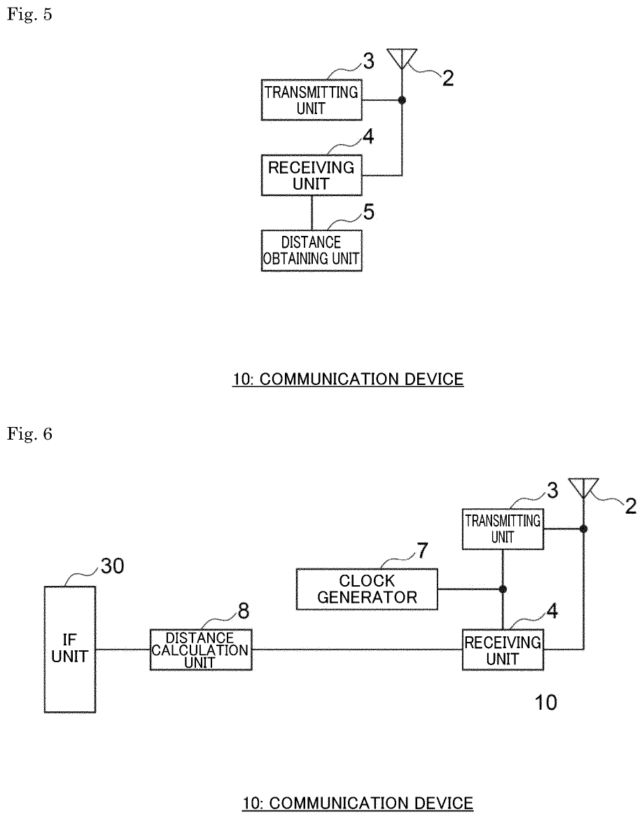

FIG. 5 is a block diagram illustrating an example of the configuration of a communication device 10. In other words, this corresponds to the configurations of the plurality of devices 10a to 10c. The communication device 10 in FIG. 5 includes an antenna 2, a transmitting unit 3, a receiving unit 4, and a distance obtaining unit 5. In the present specification, the transmitting unit 3 and the receiving unit 4 may be collectively called a “communication unit”. Each of the devices 15a to 15d has the same configuration as the communication device 10 as well.

The distance obtaining unit 5 obtains the distance information calculated on the basis of the propagation channel characteristics. Here, the propagation channel characteristics are, for example, a phase difference arising during propagation through the propagation path. The distance obtaining unit 5 may calculate the distance information within the communication device 10 of FIG. 5, or may obtain the distance information through the receiving unit 4. The distance obtaining unit 5 obtains the distance information calculated on the basis of group delay calculated from the relationships between the frequencies and the phases of the plurality of propagation channels, for example. Alternatively, the distance obtaining unit 5 may obtain the distance information directly from measured phases rather than group delay calculated from the relationships between the frequencies and the phases of the plurality of propagation channels.

The communication device 10 in FIG. 5 may perform various types of information processing based on the distance information obtained by the distance obtaining unit 5, elevation information, or the like, or may transmit the distance information, elevation information, and the like to a processing device such as a server through the transmitting unit 3.

FIG. 6 is a block diagram illustrating the communication device 10 according to the first embodiment in more detail than in FIG. 5. The communication device 10 in FIG. 2 includes the antenna 2, the transmitting unit 3, the receiving unit 4, a clock generator 7, a distance calculation unit 8, an elevation calculation unit 9, an elevation sensor 10, and an interface (IF) unit 30.

The clock generator 7 includes a local oscillator that generates a local oscillation signal used in modulation processing by the transmitting unit 3 and demodulation processing by the receiving unit 4.

The distance calculation unit 8 calculates the distance information based on the propagation channel characteristics. For example, the distance calculation unit 8 may calculate the distance information using, for example, a phase-based method or an Ultra Wide Band UWB) method. The phase-based method and the UWB method will be described in detail later. The distance calculation unit 8 includes the functionality of the distance obtaining unit 5 in FIG. 5.

The communication device 10 in FIG. 5 may be a beacon device installed in a predetermined location, or may be a wireless station such as a base station, a server, or the like that communicates wirelessly with a mobile communication device, a beacon device, or the like. As described above, the communication device 15 may be a mobile communication device such as a smartphone or a mobile phone having a configuration similar to that of the communication device 10, or may be a portable beacon device, a base station, or the like. Note that in the present embodiment, the communication devices 10 and 15 and the processing device 20 may be referred to as “communication processing devices”. In other words, the communication processing devices include all the devices 10a to 10c, the devices 15a to 15d, and the processing device 20 related to the communication processing, and each may be a mobile communication device, a beacon device, a server, or a wireless station such as a base station, a server, or the like that communicates wirelessly with a mobile communication device, a beacon device, or the like.

The communication device 10 calculates distance information to a communication partner device based on the propagation channel characteristics by communicating wirelessly with the communication partner device. The following will describe a method for calculating the distance information to a communication partner device using a phase-based method as a specific example of the propagation channel characteristics.

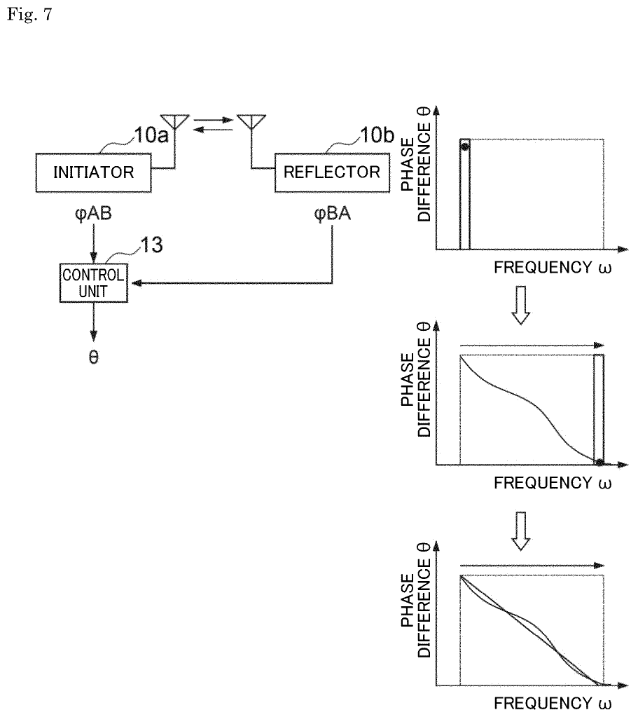

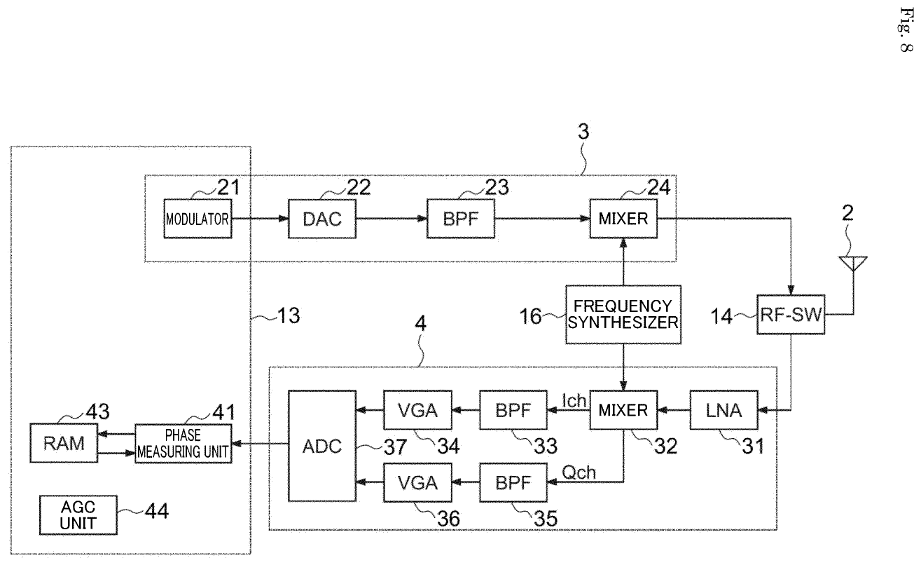

FIG. 7 is a block diagram illustrating an example of the internal configurations of a phase-based initiator 10a and reflector 10b. The internal configurations of the initiator 10a and the reflector 10b are the same. The initiator 10a and reflector 10b in FIG. 7 include the antenna 2, the transmitting unit 3, the receiving unit 4, and a control unit 13. A transmission signal output from the transmitting unit 3 and a reception signal received at the antenna 2 are switched by a high-frequency switch (RF-SW) 14. The transmitting unit 3 and the receiving unit 4 perform modulation processing and demodulation processing in synchronization with a clock output from a frequency synthesizer 16. In other words, in the example in FIG. 1, the devices 10a to 10c act as initiators or reflectors for one another.

FIG. 7 is a diagram illustrating the phase-based method. This diagram illustrates an example in which a wireless signal in a 2.4 GHz frequency band is transmitted between the initiator 10a and the reflector 10b, and a phase difference θ of the transmission channels is measured by the control unit 13. As illustrated in FIG. 7, when the horizontal axis is set to a frequency ω and the vertical axis is set to the phase difference θ, the phase difference θ changes substantially linearly according to the frequency. Group delay t can be calculated from the slope of the phase difference. The group delay t is the phase difference θ between the input waveform and the output waveform differentiated by the angular frequency ω. The phase cannot be distinguished from a phase shifted by an integral multiple of 21, and thus group delay is used as an indicator of the characteristics of the filter circuit.

When the phase difference between the transmission signal and the reception signal is represented by Od, a measured phase is represented by Om, the distance of the propagation path is represented by D, and the speed of light is represented by c, the following Formula (1) holds true.

θd(=θm+2 mm)=ωtd=ω×2D/c (1)

Differentiating both sides of Formula (1) by an angular frequency ω results in Formula (2).

$$\\ \begin{matrix}[ Math . 1 ] & \\ \frac{d {θ}_{d}}{d ω} = \frac{d {θ}_{m}}{d ω} = \frac{2 D}{c} & ( 2 )\end{matrix}$$

When Formula (2) d=tp×c is modified, the distance D is obtained through the following Formula (3).

$$\\ \begin{matrix}[ Math . 2 ] & \\ D = \frac{c}{2} \times \frac{d {θ}_{m}}{d ω} & ( 3 )\end{matrix}$$

FIG. 8 is a block diagram illustrating an example of the internal configurations of a phase-based initiator 10a and reflector 10b. The internal configurations of the initiator 10a and the reflector 10b are the same. The initiator 10a and reflector 10b in FIG. 8 include the antenna 2, the transmitting unit 3, the receiving unit 4, and the control unit 13. A transmission signal output from the transmitting unit 3 and a reception signal received at the antenna 2 are switched by the high-frequency switch (RF-SW) 14. The transmitting unit 3 and the receiving unit 4 perform modulation processing and demodulation processing in synchronization with the clock output from a frequency synthesizer 16.

The transmitting unit 3 has a modulator 21 in the control unit 13, a DA converter (DAC) 22, a band pass filter (BPF) 23, and a mixer 24. The receiving unit 4 has a low noise amplifier (LNA) 31, a mixer 32, a band pass filter (BPF) 33 and a variable gain amplifier (VGA) 34 for the I channel, a BPF 35 and a VGA 36 for the Q channel, and an AD converter (ADC) 37.

The control unit 13 has the modulator 21, a phase measuring unit 41, a RAM 43, and an automatic gain control unit (AGC) 44.

A digital demodulation signal output from the receiving unit 4 is stored in the RAM 43 after the phase difference measurement for the transmission signal and the reception signal is performed by the phase measuring unit 41 for each frequency channel. The digital demodulation signal is also stored in the RAM 43 in time series by associating, with device combinations, the radio wave strength at each frequency of the propagation channels among the devices 10a to 10c and the devices 15a to 15d.

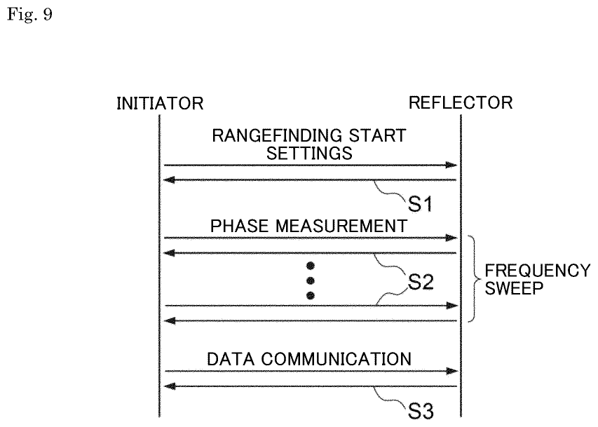

FIG. 9 is a diagram illustrating an example of a signal sequence transmitted between the phase-based initiator 10a and reflector 10b. First, settings for starting rangefinding are made (step S1). In step S1, for example, device authentication, negotiation, frequency offset correction, AGC gain setting, and the like are performed to determine whether the device is a Bluetooth Low Energy (BLE)-compliant device. In negotiation, whether the device is capable of rangefinding, rangefinding setting parameters, and the like are confirmed.

Next, for example, a frequency sweep is performed within the range of 2400 MHz to 2480 MHz, which is used by BLE, and phase measurement is performed for each frequency channel to calculate the distance information (step S2). Once the distance information is calculated in step S2, data communication is performed between the initiator 10b and the reflector 10b (step S3), and data including the distance information, elevation information, and the like is exchanged.

As illustrated in FIG. 7, the initiator 10a transmits a single carrier signal to the reflector 10b, but due to the influence of the local phase in only one direction, from the initiator 10a to the reflector 10b, the phase difference of the propagation path cannot be detected correctly. Accordingly, in the phase-based method, processing is performed to cancel the local phase by reciprocating a signal between the initiator 10a and the reflector 10b.

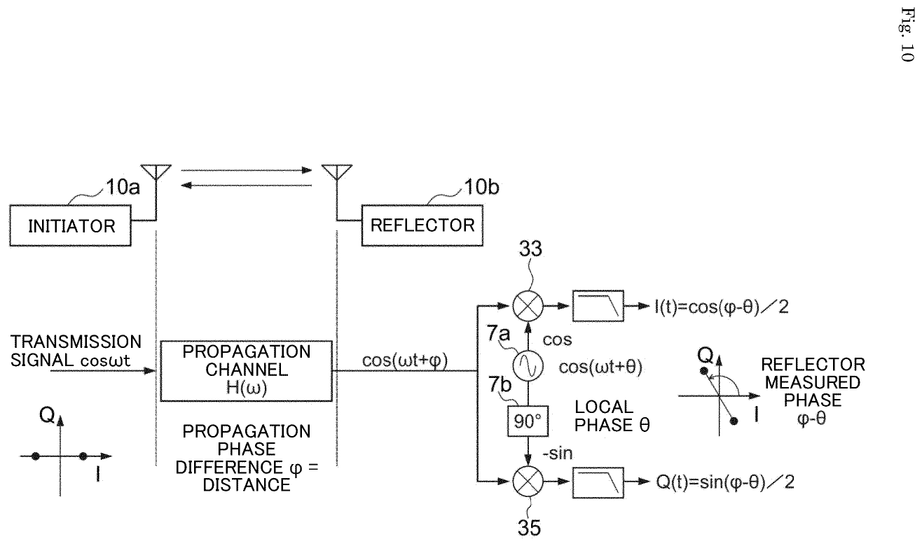

FIGS. 10 to 12 are diagrams illustrating the method for cancelling the local phase. As illustrated in FIGS. 10 to 12, the frequency synthesizer 16 of FIG. 4 has a local oscillator 7a and a 90-degree phase shifter 7b. FIG. 7 illustrates an example in which a transmission signal cos ωt, which is converted into an intermediate frequency signal by a local oscillation signal, is transmitted from the initiator 10a to the reflector 10b. In FIG. 10, the phase difference between the transmission signals propagating through the propagation path is represented by q. In this case, the reflector 10b receives a signal cos(ωt+q). If the local oscillator 7a in the reflector 10b has a local phase θ, the local oscillation signal is represented by cos(ωt+q). Accordingly, the I signal generated by the reflector 10b is represented by I(t)=cos(φ−θ)/2, and the Q signal is represented by Q(t)=sin(φ−θ)/2.

In this manner, the measured phase of the reflector 10b is φ−θ. The measured phase can be detected by an operator or the like provided in the reflector 10b. The operator is, for example, built into an Integrated Circuit (IC) chip that performs the functions of the reflector 10b.

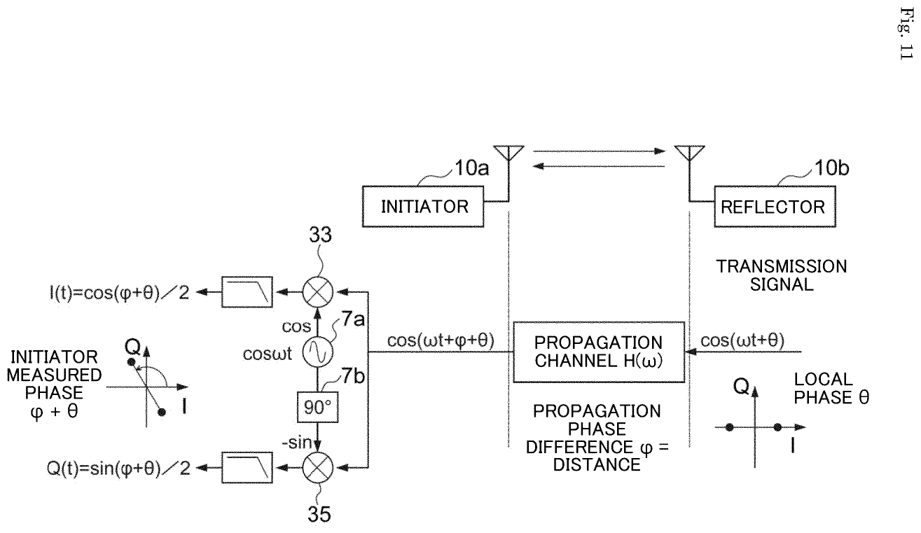

FIG. 11 illustrates an example in which a transmission signal cos(ωt+θ), which is converted into an intermediate frequency signal by a local oscillation signal, is transmitted from the reflector 10b to the initiator 10b. θ represents the local phase of the local oscillator 7a of the reflector 10b, as described above. In this case, the initiator 10b receives a signal cos(ωt+φ+θ). Accordingly, the I signal generated by the initiator 10b is represented by I(t)=cos(φ+θ)/2, and the Q signal is represented by Q(t)=sin(φ+θ)/2.

In this manner, the measured phase of the initiator 10b is φ+θ. The measured phase can be detected by an operator or the like provided in the initiator 10b. The operator is, for example, built into an IC chip that performs the functions of the initiator 10b.

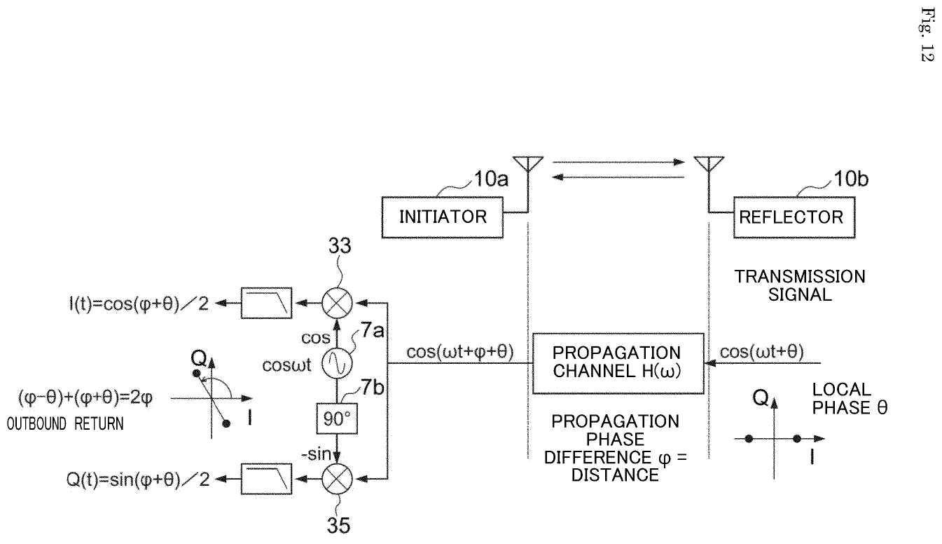

FIG. 12 illustrates an example of adding the measured phase (φ−θ) in the reflector 10b in FIG. 10 and the measured phase (φ+θ) in the initiator 10b in FIG. 8. It can be seen that (φ−θ)+(φ+θ)=2φ, which can cancel out the influence of the local phase. The addition operation can be performed by an operator or the like in the IC chip for the reflector 10b or the initiator 10b described above.

In this manner, by reciprocating a signal between the initiator 10b and the reflector 10b, the phase difference of the transmission channel can be detected without being affected by the local phase θ. If the phase difference of the propagation path can be detected, the distance of the propagation path can be calculated according to the above-described Formulas (1) to (3).

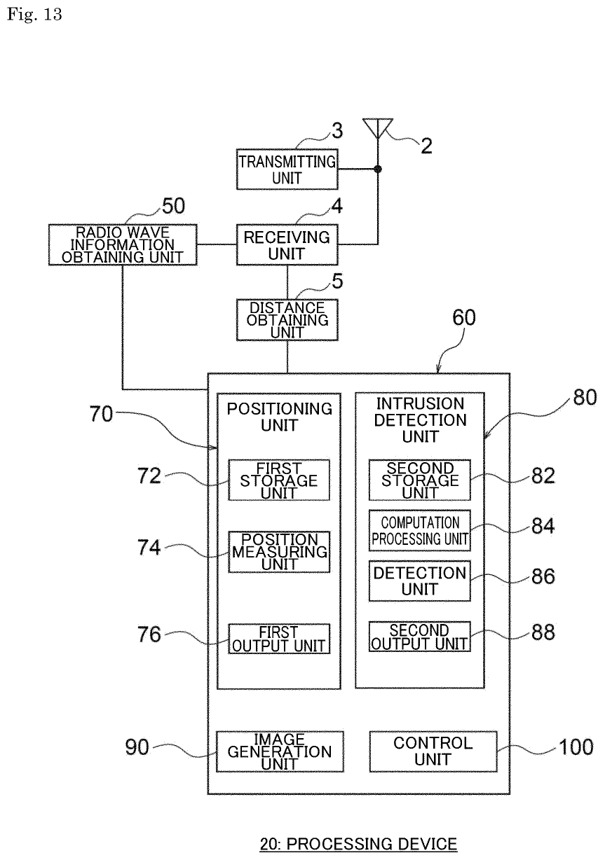

FIG. 13 is a block diagram illustrating an example of the configuration of the processing device 20. As illustrated in FIG. 13, the processing device 20 includes the antenna 2, the transmitting unit 3, the receiving unit 4, the distance obtaining unit 5, a radio wave information obtaining unit 50, and a processing unit 60. The processing unit 60 has a positioning unit 70, an intrusion detection unit 80, an image generation unit 90, and a control unit 100. The processing device 20 includes hardware necessary for the configuration of a computer, such as a Central Processing Unit (CPU), a Read Only Memory (ROM), a Random Access Memory (RAM), a Hard Disk Drive (HDD), and the like. The CPU implements each function block illustrated in FIG. 13 by loading a program according to the present technique stored in the ROM or the HDD into the RAM and executing the program. A control method according to the present technique is executed by these function blocks. As described above, the processing device 20 may communicate with the devices 10a to 10c over wires.

The specific configuration of the processing unit 60 is not limited, and devices such as a Field Programmable Gate Array (FPGA), an image processing Integrated Circuit (IC), and other Application Specific Integrated Circuits (ASICs) may be used.

The radio wave information obtaining unit 50 obtains information about the communication radio waves among the plurality of devices 10a to 10c from the plurality of devices 10a to 10c.

The positioning unit 70 has a first storage unit 72, a position measuring unit 74, and a first output unit 76. The intrusion detection unit 80 has a second storage unit 82, a computation processing unit 84, a detection unit 86, and a second output unit 88. The image generation unit 90 generates an image indicating a processing result from at least one of the positioning unit 70 and the intrusion detection unit 80.

The control unit 100 controls each element of the processing device 20. The control unit 100 can perform control to switch between a first mode for detecting a person/object using the intrusion detection unit 80 and a second mode for detecting the position of a target object using the positioning unit 70. The image indicating the processing result, generated by the image generation unit 90, is displayed in the display device 25.

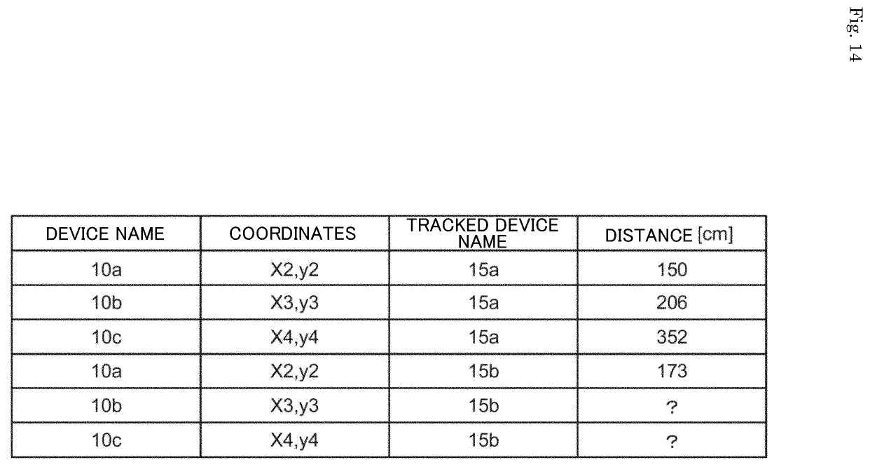

The positioning unit 70 will be described first. FIG. 14 is a diagram illustrating an example of distance information stored in the first storage unit 72. As illustrated in FIG. 14, the distance obtaining unit 5 stores the information about the distance obtained in the first storage unit 72 in association with a tracked device name. To simplify the descriptions, two-dimensional coordinates are used, but three-dimensional coordinates may be used instead. This information is stored in time series in association with the tracked device name, but is reset at predetermined time intervals. The predetermined time interval is 1 second, for example. In other words, the position of the tracked device is measured at 1-second intervals.

The position measuring unit 74 determines whether there are at least three instances of distance information corresponding to the tracked device name. If there are at least three instances of information, the position coordinates for the tracked device name are calculated using the principle of triangulation, for example, and stored in the first storage unit 72 in time series. For example, there will be at least three instances of distance information for a tracked device 15a at a given timing, and thus the position measuring unit 74 stores the position coordinates of the tracked device 15a in the first storage unit 72 in time series. On the other hand, there will not be at least three instances of distance information for a tracked device 15b at a given timing, and thus the position measuring unit 74 stores the position coordinates of the tracked device 15a in time series in the first storage unit 72 in association with a code Z, which indicates “unknown”. For example, the code Z is recorded when a child enters under an object that interferes with electromagnetic waves, such as a desk. The first output unit 76 outputs a positioning signal including the information measured by the position measuring unit 74 to the image generation unit 90, the transmitting unit 3, and the like.

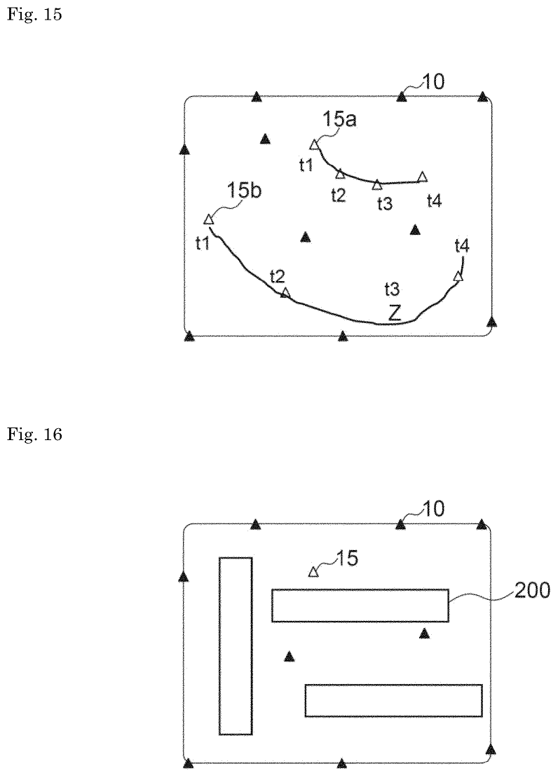

FIG. 15 is an example of an image indicating a processing result, generated by the image generation unit 90. The black triangles indicate, for example, the position of the device 10. As illustrated in FIG. 15, the image generation unit 90 generates, as an image, the positions of the tracked devices in time series (t1 to tn), and identification information indicating the devices 15a and 15b. The image generation unit 90 can connect the chronological positions of the tracked device together with splines, for example. These images are displayed in the display device 25 under the control of the control unit 100. This makes it possible for an observer to monitor a child's activity state in more detail, such as when the code Z arises continuously and the child is absent, the child has stopped moving for a predetermined period of time, and the like.

FIG. 16 is another example of an image indicating a processing result, generated by the image generation unit 90. Black squares 200 indicate the positions of display shelves. As illustrated in FIG. 16, the image generation unit 90 generates an image indicating, for example, the positions of the display shelves 200 in a museum and the positions of the device 10, every predetermined timing, e.g., every 1 second. These images can be sent to the device 15, for example, and displayed on the screen of the device 15 under the control of the control unit 100. This makes it possible for the holder of the device 15 to ascertain their position in a building such as a museum.

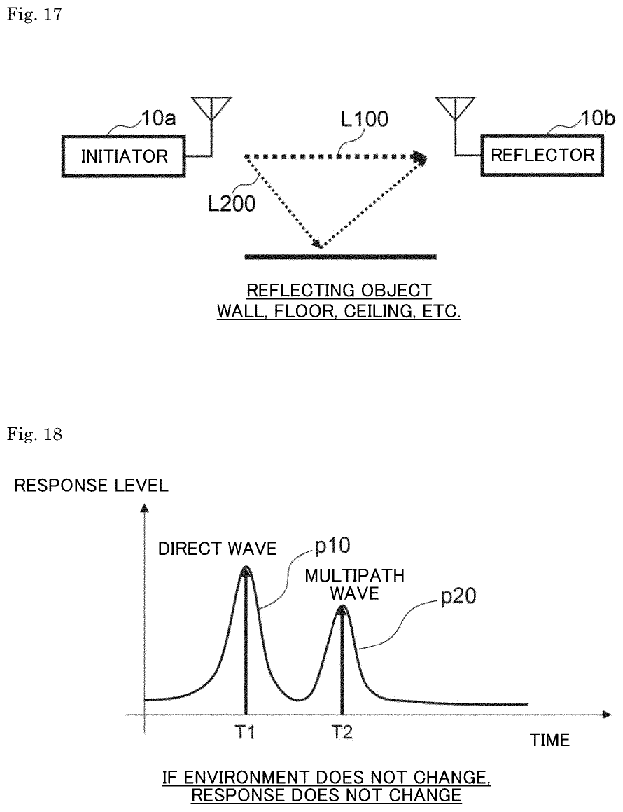

Measured radio waves used by the intrusion detection unit 80 will be described next with reference to FIGS. 17 to 24. FIG. 17 is a diagram illustrating, for example, an example of the propagation paths of radio waves during radio wave measurement. The propagation paths include a direct path L100 and a plurality of multipaths L200. An arrival time τ1 of direct waves via the direct path L100 is represented by τ1=d/c. In other words, this value is obtained by dividing a distance d by the speed of light c.

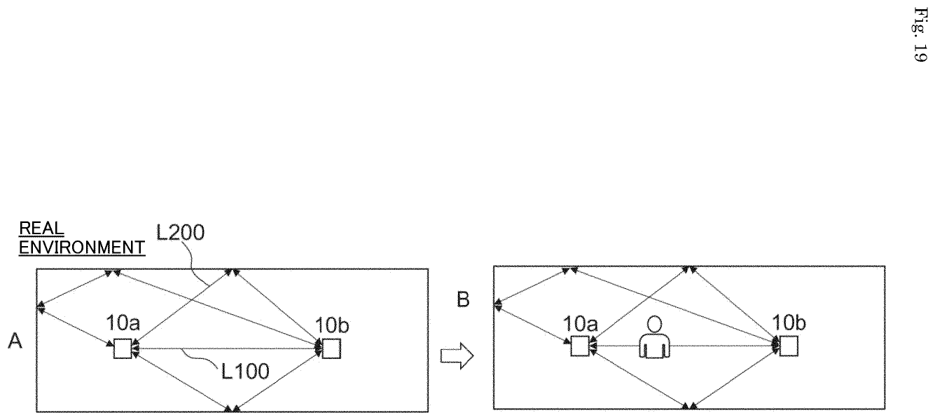

FIG. 18 is a diagram illustrating an example of response characteristics of direct waves in the direct path L100 and multipath waves in the multipaths L200 illustrated in FIG. 17. The horizontal axis represents time, and the vertical axis represents the response level of the communication radio waves. As illustrated in FIG. 18, a peak p10 of the direct waves appears at time τ1, and a peak P20 of the multipath waves appears at time τ2, which is later than time τ1. The radio wave information obtaining unit 50 obtains these response waveforms from each of the devices 10a to 10c and stores those waveforms in the second storage unit 82 in association with the information among the plurality of devices 10a to 10c.

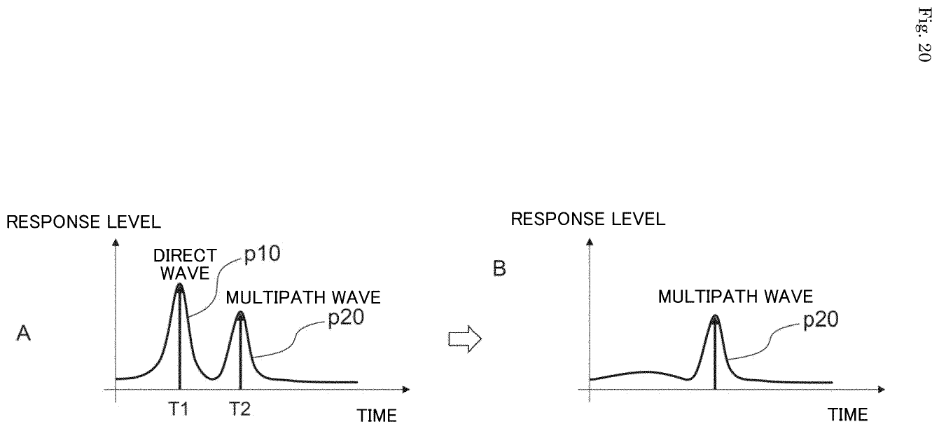

FIG. 19 is a diagram illustrating direct waves in the direct path L100 and the multipaths L200, simulating a real environment. A is a diagram illustrating an example in which there is no intruder, and B is a diagram illustrating an example in which an intruder enters the direct path L100.

FIG. 20 is a diagram illustrating an example of response characteristics of direct waves in the direct path L100 and multipath waves in the multipaths L200 illustrated in FIG. 17. The horizontal axis represents time, and the vertical axis represents the response level. A is a diagram illustrating an example in which there is no intruder, and B is a diagram illustrating an example in which an intruder enters the direct path L100. As indicated in B, when an intruder enters the direct path L100, the peak p10 of the direct waves is attenuated, and the response level of the radio waves changes.

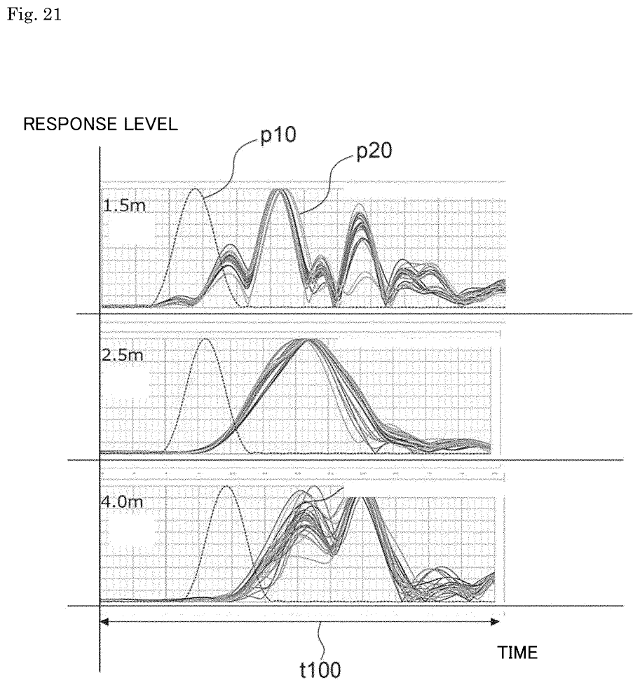

FIG. 21 is a diagram illustrating an example of response characteristics of direct waves in the direct path L100 and multipath waves in the multipaths L200 in a real environment. In this example, an intruder enters the direct path L100.

The horizontal axis represents time, and the vertical axis represents the response level. In this example, the distances from devices are, from the top, 1.5, 2.5, and 40 meters. Although the peak p10 of the direct waves is provided for reference, this peak is attenuated in reality. In FIG. 21, 30 measurement results are displayed. In this manner, in actual measurements, the response level is measured repeatedly during a predetermined time interval t100 starting when the communication among the devices 10a to 10c is started.

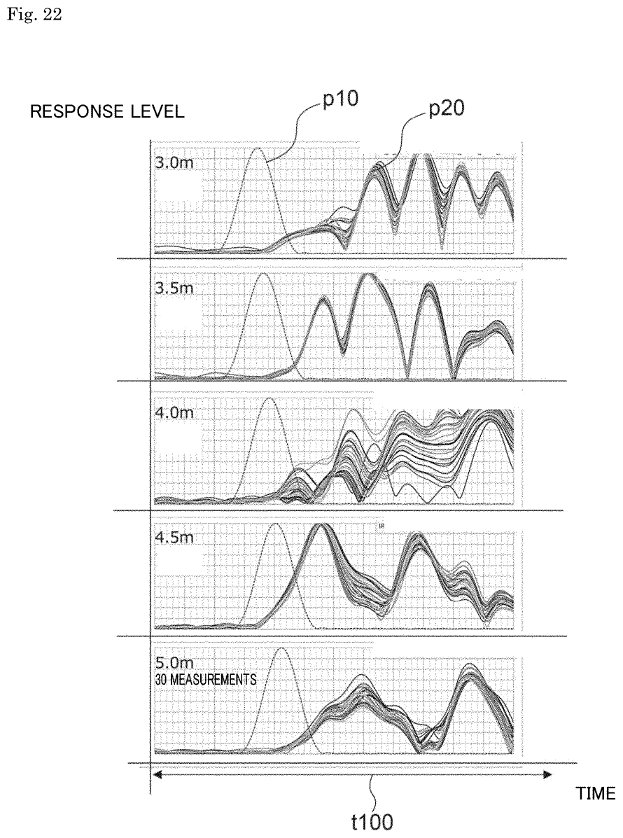

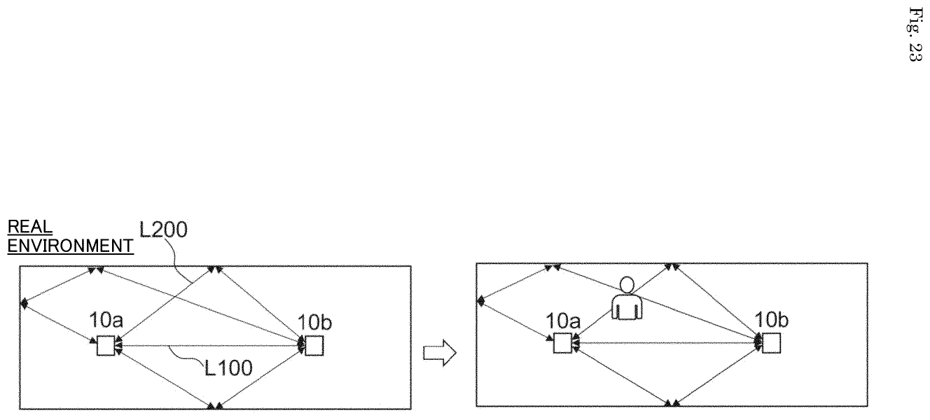

FIG. 22 is a diagram illustrating an example of response characteristics of direct waves in the direct path L100 and multipath waves in the multipaths L200 in a real environment different from that in FIG. 21. In this example, an intruder enters the direct path L100. The horizontal axis represents time, and the vertical axis represents the response. In this example, the distances from devices are, from the top, 3.0, 3.5, 4.0, 4.5, and 5.0 meters. Although the peak p10 of the direct waves is provided for reference, this peak is attenuated in reality. In FIG. 22, 30 measurement results are displayed. In this manner, the level of the response waves changes drastically when an intruder enters the direct path L100.

FIG. 23 is a diagram illustrating an example of the multipaths L200 when an intruder is present, simulating a real environment. A is a diagram illustrating an example in which there is no intruder, and B is a diagram illustrating an example in which an intruder enters the multipaths L200.

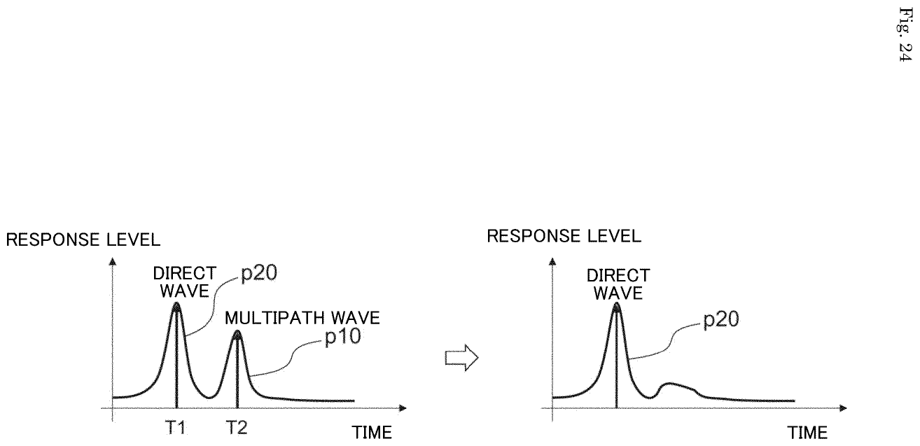

FIG. 24 is a diagram illustrating an example of response characteristics of direct waves in the direct path L100 and multipath waves in the multipaths L200 illustrated in FIG. 23. The horizontal axis represents time, and the vertical axis represents the response level. A is a diagram illustrating an example in which there is no intruder, and B is a diagram illustrating an example in which an intruder enters the multipaths L200. As indicated in B, when an intruder enters the multipaths L200, the peak p20 of the multipath waves is attenuated, and the response level of the radio waves changes.

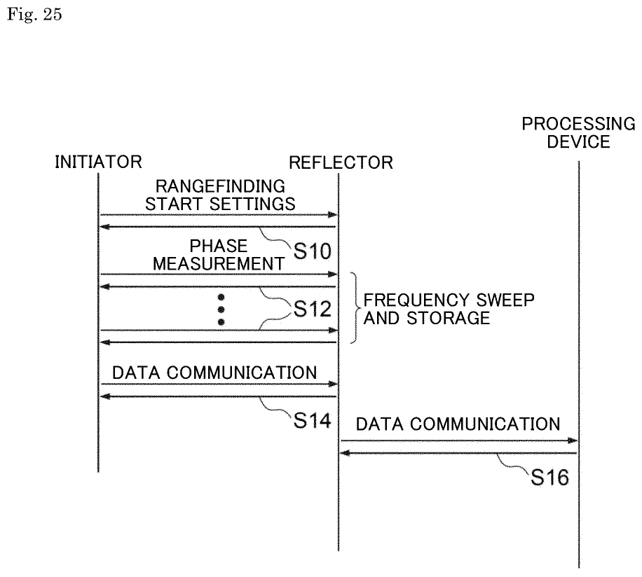

Here, an example of a signal sequence transmitted between the initiator 10a, the reflector 10b, and the processing device 20 will be described. FIG. 25 is a diagram illustrating an example of a signal sequence transmitted between the phase-based initiator 10a and reflector 10b. As illustrated in FIG. 25, in the present embodiment, the response level of the communication radio waves in a positioning mode (the second mode) can be used for monitoring. In other words, an intruder or the like is detected using fluctuations in the radio waves during rangefinding between the initiator 10a and reflector 10b, whose positions are fixed.

First, settings for starting rangefinding are made (step S10). In step S10, for example, device authentication, negotiation, frequency offset correction, AGC gain setting, and the like are performed to determine whether the device is a Bluetooth Low Energy (BLE)-compliant device. In negotiation, whether the device is capable of rangefinding, rangefinding setting parameters, and the like are confirmed.

Next, for example, a frequency sweep is performed within the range of 2400 MHZ to 2480 MHz, which is used by BLE, and phase measurement is performed for each frequency channel to calculate the distance information. At the same time, the radio wave strength for each frequency in the propagation channels among the devices 10a to 10c and 15a to 15d is stored in the RAM 43 (see FIG. 8) in time series, in association with device combinations (step S12).

Once the distance information is calculated in step S12, data communication is performed between the initiator 10b and the reflector 10b (step S13), and data including the distance information, elevation information, and the like is exchanged.

Next, data communication is performed between the initiator 10b and the reflector 10b (step S14); information on the radio wave strength for each frequency of the propagation channels among the devices 10a to 10c and the devices 15a to 15d is associated with a device combination and time information; and the information is transmitted to the processing device 20 in time series.

The processing device 20 associates the information on the radio wave strength for each frequency of the propagation channels among the devices 10a to 10c and the devices 15a to 15d with a device combination and the time information, and stores the information in the second storage unit 82 (see FIG. 13) in time series. The first storage unit 72 and the second storage unit 82 may be configured as a common storage unit.

Here, the intrusion detection unit 80 will be described with reference to FIG. 13 again. The computation processing unit 84 performs operations related to a comparison values between the radio wave strength for each frequency of the propagation channels among the devices 10a to 10c, stored in the second storage unit 82 when observation starts, and the radio wave strength for each frequency of the propagation channels among the devices 10a to 10c, which is newly obtained. For example, the computation processing unit 84 calculates a difference value of the radio wave response level for each frequency within a predetermined time from the start of communication among the devices 10a to 10c, and integrates the absolute values of those difference values. If the integral value is within a predetermined value, the detection unit 86 detects “no intrusion”. On the other hand, if the integral value is greater than the predetermined value, an “intrusion” is detected.

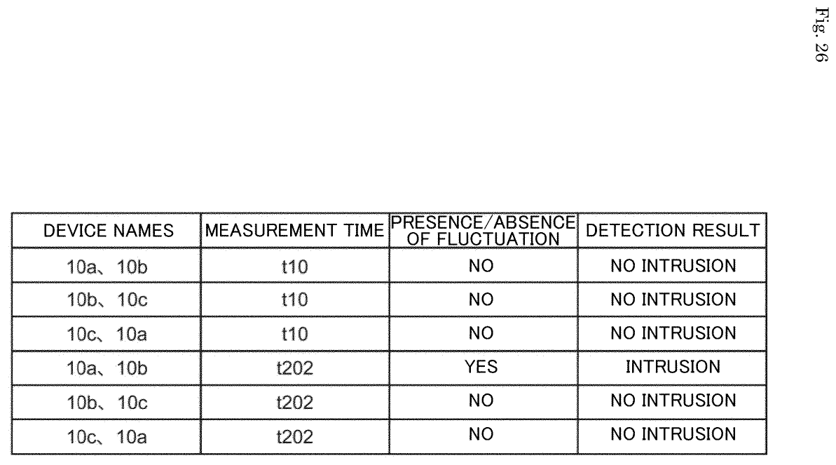

FIG. 26 is a diagram illustrating an example of the detection result from the detection unit 86. As illustrated in FIG. 26, the detection unit 86 stores the detection results in the storage unit 82 in time series (t1 to tn) by associating the combinations of the devices 10a to 10c and the measurement times with the detection results. Note that FIG. 26 illustrates t10 and t202 as examples.

When an intrusion is detected, the detection unit 86 generates an alarm signal, including information indicating there is an intrusion and information about the time, for the alarm device 40. As illustrated in FIG. 26, the detection unit 86 can also detect an intrusion for each combination of the devices 10a to 10c.

The second output unit 88 outputs the alarm signal generated by the detection unit 86 to the image generation unit 90, the transmitting unit 3, and the like under the control of the control unit 100. The transmitting unit 3 then supplies the alarm signal to the alarm device 40. The processing device 20 may also transmit the alarm signal to a predetermined mobile terminal or the like.

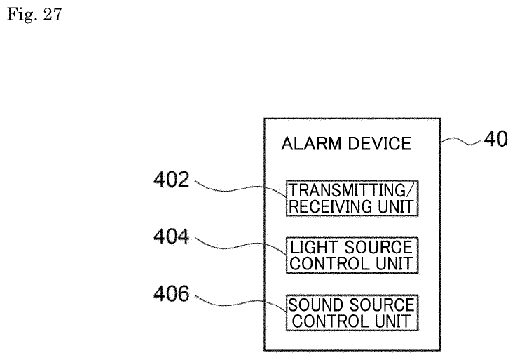

FIG. 27 is a block diagram illustrating an example of the configuration of the alarm device 40. As illustrated in FIG. 27, the alarm device 40 has a receiving unit 402, a light source control unit 404, and a sound source control unit 406.

The receiving unit 402 receives the alarm signal supplied from the detection unit 86. The light source control unit 404 controls a light intensity of a light source provided in an intrusion warning area, for example. The light source control unit 404 performs control to increase the light intensity of the light source when the alarm signal is received, for example. The sound source control unit 406 performs control to output a predetermined sound from a sound source, e.g., a speaker, provided in the intrusion warning area. The sound source control unit 406 performs control to output the predetermined sound when the alarm signal is received, for example. In this manner, by measuring the radio wave strengths among the devices 10a to 10c used for rangefinding, it is possible to detect the intrusion of a person, an object, an animal, or the like into a specific area without adding a new device.

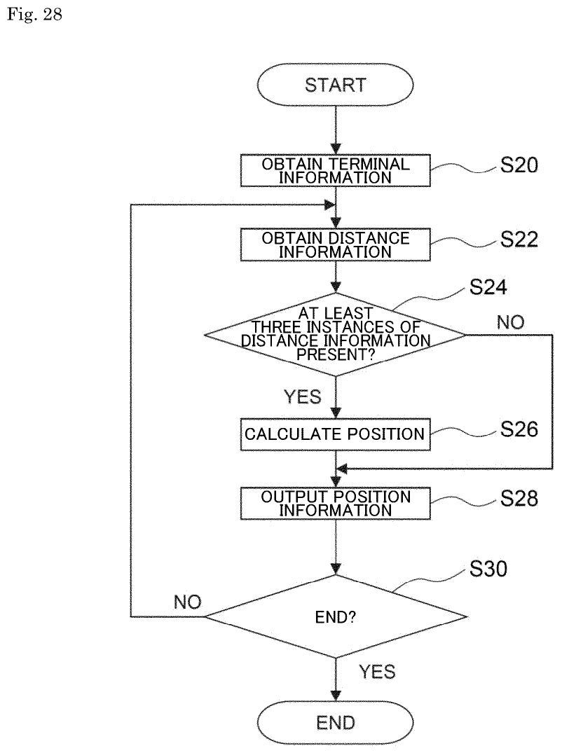

FIG. 28 is a flowchart illustrating positioning processing operations in the processing device 20. An example of generating an image based on a positioning result will be described here.

First, the distance obtaining unit 5 obtains the identification information (device names) and planar coordinate information of the devices 10a to 10c (step S20). In step S20, self-coordinate information of each device sent from the devices 10a to 10c is obtained and stored in the first storage unit 72 in association with the corresponding device name.

Next, the distance obtaining unit 5 obtains the distance information of the devices 15a to 15d and the devices 10a to 10c from the devices 15a to 15d, and stores the distance information in the first storage unit 72 in association with the name of the device being measured (step S22).

Next, the position measuring unit 74 determines whether there are at least three instances of distance information for each of the devices 15a to 15d (step S24). If there are not at least three instances of distance information (NO in step S24), the position measuring unit 74 stores the code Z in association with the information in the first storage unit 72. On the other hand, if there are at least three instances of distance information (YES in step S24), the positions of the devices 15a to 15d are calculated (step S26) and stored in the first storage unit 72 in association with the respective names of the devices 15a to 15d to be measured.

Next, the position measuring unit 74 outputs the position information of the devices 15a to 15d to the image generation unit 90 (step S28). The image generation unit 90 then generates an image in which the names of the devices 15a to 15d are associated with the corresponding position information. The processing device 20 then causes the generated images to be displayed in the display device 25.

Next, the control unit 100 determines whether to continue the processing (step S30), and if so (NO in step S30), repeats the processing from step S22. On the other hand, if the processing is to be ended (YES in step S30), the overall processing ends.

In this manner, in the first embodiment, the processing device 20 obtains the distance information of the devices 15a to 15d and the devices 10a to 10c from the devices 10a to 10c, and thus the positions of the devices 15a to 15d can be detected accurately. In addition, because this information is converted into images, it is easy to observe the positions of the devices 15a to 15d.

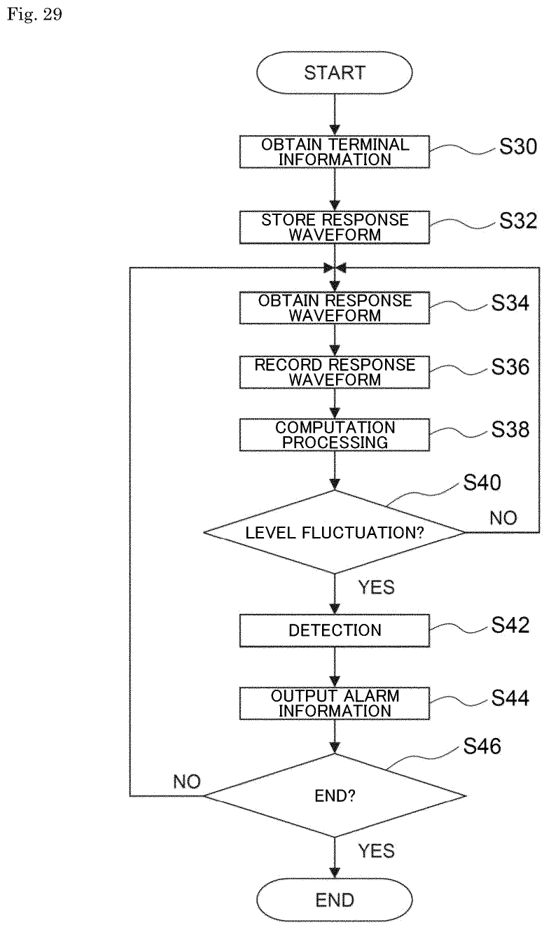

FIG. 29 is a flowchart illustrating monitoring processing operations in the processing device 20. First, the radio wave information obtaining unit 50 obtains combination information about the device names of the devices 10a to 10c, and information about initial radio wave response when the observation is started (step S30). Next, information about the radio wave strength of each device sent from the devices 10a to 10c is stored in the second storage unit 82 in association with the device names (step S32).

Next, the radio wave information obtaining unit 50 obtains the combination information about the device names of the devices 10a to 10c and information about observed radio wave response at predetermined time intervals (step S34). Next, information about the radio wave strength of each device sent from the devices 10a to 10c is stored in the second storage unit 82 in association with the device names (step S36).

Next, the computation processing unit 84 calculates a difference value between the radio wave response level at the start of communication among the devices 10a to 10c and the newly-obtained radio wave response level, and integrates the absolute values of those difference values (step S38). Next, the detection unit 86 determines whether the integral value is within a predetermined value (step S40). If the integral value is within a predetermined value (NO in step S40), the detection unit 86 determines there is “no intrusion”, and repeats the processing from step S34. On the other hand, if the integral value is determined to be greater than the predetermined value (YES in step S40), the detection unit 86 detects an “intrusion” (step S42).

The detection unit 86 then generates the alarm signal, including the alarm information, and outputs the alarm signal to the alarm device 40 through the second output unit 88 (step S44). Then, the control unit 100 determines whether to continue the monitoring processing (step S46), and if so (NO in step S46), repeats the processing from step S34. On the other hand, if the processing is to be ended (YES in step S46), the overall processing ends.

In this manner, in the first embodiment, the radio wave strength levels among the devices 10a to 10c are compared in time series, and thus the time when the radio wave strength levels change can be detected as the time when an intruder or the like has intruded. Through this, by measuring the radio wave strengths and the like among the devices 10a to 10c used for rangefinding, it is possible to detect the intrusion of a person, an object, an animal, or the like into a specific area without adding a new device.

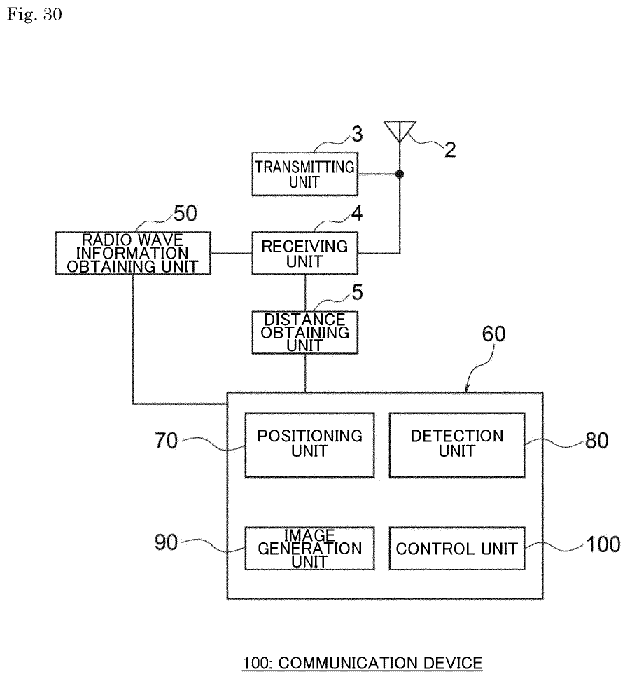

Here, an example of a variation on the communication system 1 when the communication devices 10 and 15 have positioning functions and monitoring functions will be described with reference to FIGS. 30 to 36. FIG. 30 is a block diagram illustrating a case where a communication device 100 has a positioning function and a monitoring function. As described above, the communication device 100 may be a mobile communication device such as a smartphone or a mobile phone, a beacon device installed in a predetermined location, or a wireless station such as a base station, a server, or the like that communicates wirelessly with a mobile communication device, a beacon device, or the like.

FIG. 31 is a diagram illustrating an example in which the communication device 100 illustrated in FIG. 30 is provided as a beacon device. As illustrated in FIG. 31, by configuring the communication device 100 to have a positioning function and a monitoring function, the communication device 100 can perform processing equivalent to that performed by the processing device 20.

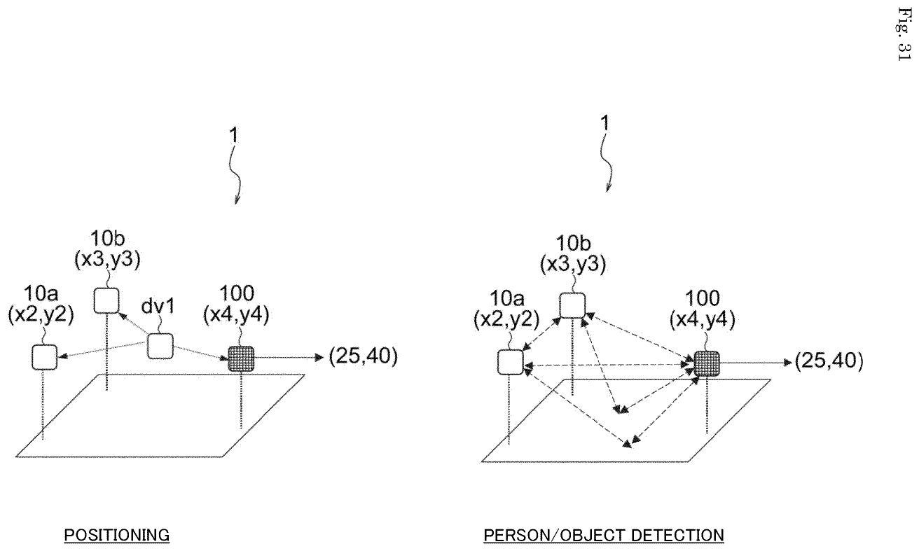

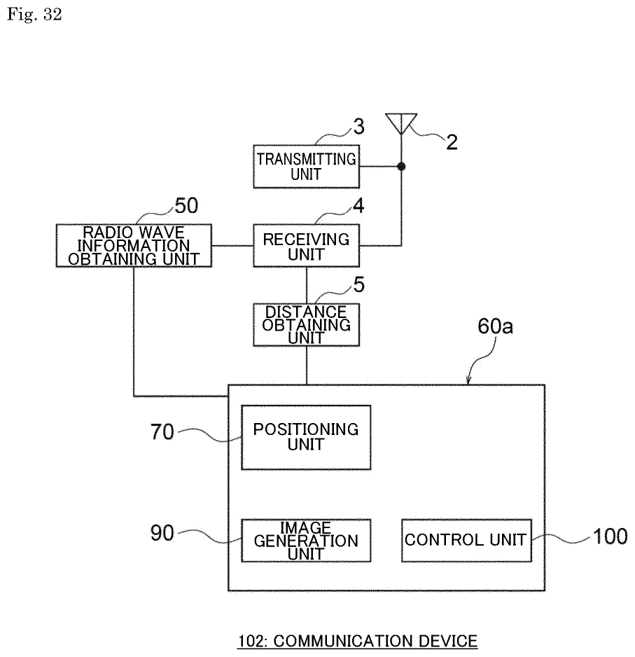

FIG. 32 is a block diagram illustrating a case where a communication device 102 has a positioning function. As described above, the communication device 102 may be a mobile communication device such as a smartphone or a mobile phone, a beacon device installed in a predetermined location, or a wireless station such as a base station, a server, or the like that communicates wirelessly with a mobile communication device, a beacon device, or the like.

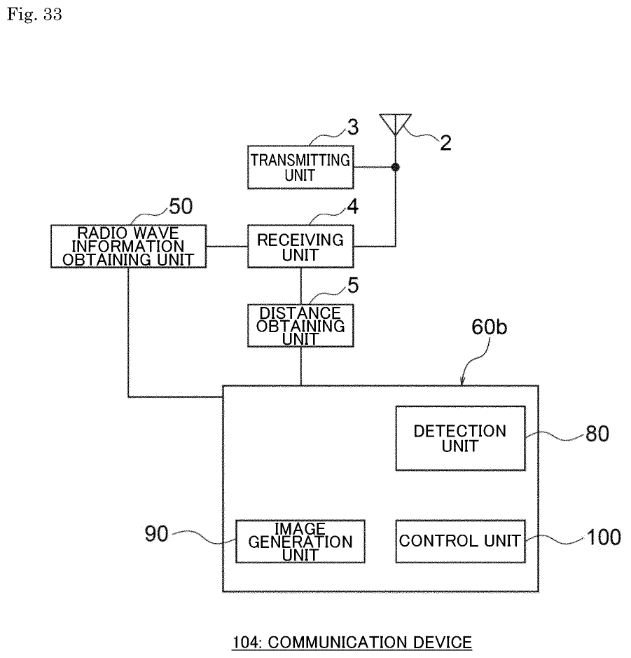

FIG. 33 is a block diagram illustrating a case where a communication device 104 has a monitoring function. As described above, the communication device 102 may be a mobile communication device such as a smartphone or a mobile phone, a beacon device installed in a predetermined location, or a wireless station such as a base station, a server, or the like that communicates wirelessly with a mobile communication device, a beacon device, or the like.

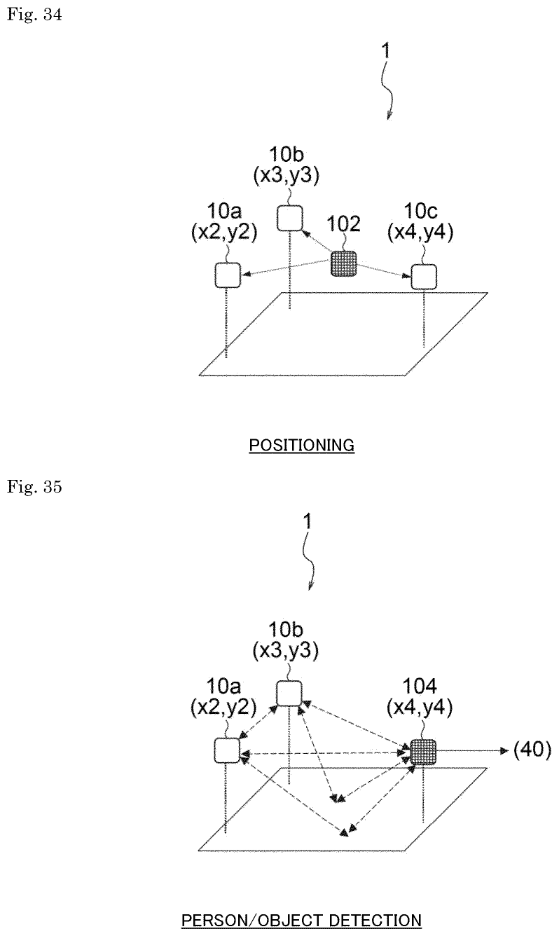

FIG. 34 is a diagram illustrating an example in which the communication device 102 illustrated in FIG. 32 is provided as a mobile communication device. As illustrated in FIG. 34, by configuring the communication device 102 to have a positioning function, the communication device 102 can perform processing equivalent to that performed by the processing device 20. This makes it possible, for example, to display a location in the museum illustrated in FIG. 16 using the mobile communication device.

FIG. 35 is a diagram illustrating an example in which the communication device 104 illustrated in FIG. 33 is provided as a beacon device. As illustrated in FIG. 35, by configuring the communication device 104 to have a monitoring function, the communication device 104 can perform processing equivalent to that performed by the processing device 20. This makes it possible, for example, to implement the child monitoring display illustrated in FIG. 15 using the communication device 104. On the other hand, positioning is performed by the processing device 20 in this example.

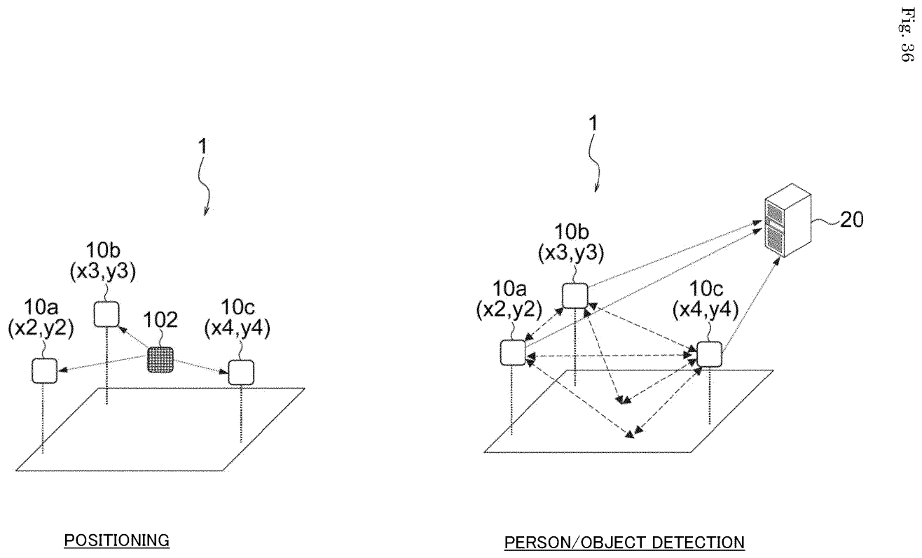

FIG. 36 is a diagram illustrating an example in which the communication device 102 is used as a mobile communication device during positioning, and the processing device 20 is used during monitoring. This makes it possible, for example, to display a location in the museum illustrated in FIG. 16 using the mobile communication device. Then, at night and the like, when the communication device 102 is not present, the monitoring can be performed by the processing device 20 in the same manner as described above.

As described above, according to the present embodiment, the positioning unit 70 obtains the distance information about the devices 15a to 15d and the devices 10a to 10c from the devices 10a to 10c, and thus the positions of the devices 15a to 15d can be detected accurately. In addition, because this information is converted into images, it is easy to observe the positions of the devices 15a to 15d.

In addition, the intrusion detection unit 80 compares the radio wave strength levels among the devices 10a to 10c in time series, and thus the time when the radio wave strength levels have changed can be detected as an intrusion by an intruder or the like. Through this, by measuring the radio wave strengths among the devices 10a to 10c used for rangefinding, it is possible to detect the intrusion of a person, an object, an animal, or the like into a specific area without adding a new device.

### Variation on First Embodiment

The communication system 1 according to a variation on the first embodiment differs from the communication system 1 according to the first embodiment in that broadband signals at a bandwidth of 500 MHz or higher are used for the communication between devices. The following will describe the differences from the communication system 1 according to the first embodiment.

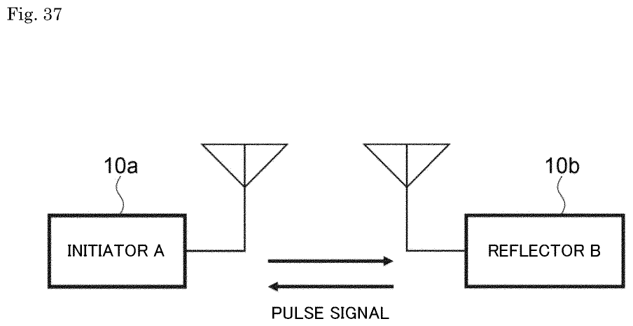

FIG. 37 is a diagram illustrating an example of a measurement signal during radio wave measurement in the communication device 10. The measurement signal uses a broadband signal at a bandwidth of 500 MHz or higher, for example. This broadband signal uses, for example, Ultra Wide Band (UWB).

In this case, the distance measurement differs from the communication system 1 according to the first embodiment in that a pulse measurement is used instead of a frequency sweep.

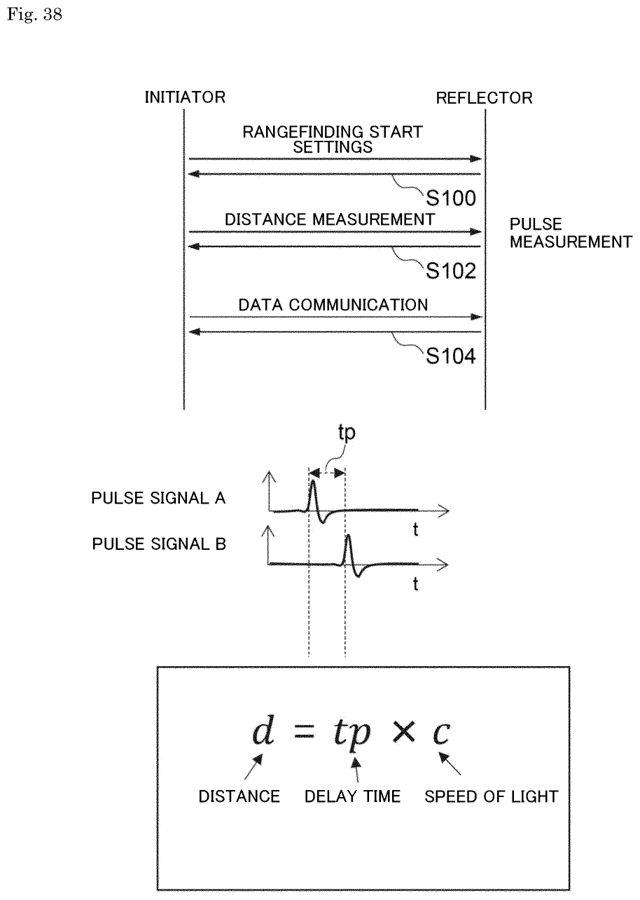

FIG. 38 is a diagram illustrating an example of a signal sequence transmitted between a pulse measurement-based initiator 10a and reflector 10b in distance measurement. As illustrated in FIG. 38, first, settings for starting rangefinding are made (step S100). In step S100, for example, device authentication is performed to determine whether the device is a UWB-compliant device. In this negotiation, whether the device is capable of rangefinding, rangefinding setting parameters, and the like are confirmed.

Next, for example, the initiator 10a transmits a pulse signal A at 500 MHz, which is used in UWB, and receives a pulse signal B in response to the pulse signal A.

For example, the reflector 10b that has received the pulse signal A of the initiator 10a transmits the pulse signal B (step S102). Accordingly, in the distance obtaining unit 5 of the initiator 10a uses the following formula

$$\\ \begin{matrix}[ Math . 3 ] & \\ d = tp \times c & \end{matrix}$$

and then multiplies

Measurement interval tp of the pulse by the speed of light c provides distance information d. Once the distance information is calculated in step S100, data communication is performed between the initiator 10b and the reflector 10b (step S104), and data including the distance information, elevation information, and the like is exchanged. The subsequent positioning processing can be performed in the same manner as in the first embodiment.

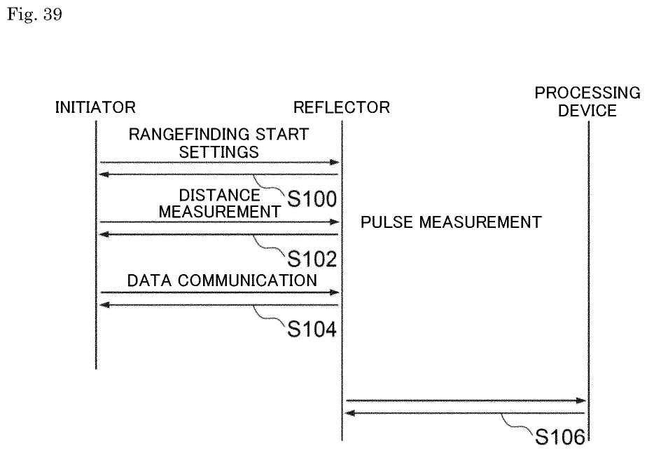

FIG. 39 is a diagram illustrating an example of a signal sequence transmitted between a pulse measurement-based initiator 10a and reflector 10b in monitoring processing. As illustrated in FIG. 39, in the present embodiment, the response level of the communication radio waves in a positioning mode (the second mode) is used for monitoring. In other words, an intruder or the like is detected using fluctuations in the radio waves during rangefinding between the initiator 10a and reflector 10b, whose positions are fixed. Steps S100 to S102 are the same as in FIG. 38.

Next, data communication is performed between the initiator 10b and the reflector 10b (step S14); information on the radio wave strengths among the devices 10a to 10c and the devices 15a to 15d is associated with a device combination and time information; and the information is transmitted to the processing device 20 in time series. The processing device 20 associates the information on the radio wave strengths among the devices 10a to 10c and the devices 15a to 15d with a device combination and the time information, and stores the information in the second storage unit 82 (see FIG. 13) in time series. The subsequent monitoring processing can be performed in the same manner as in the first embodiment.

As described above, according to the present embodiment, broadband signals at a bandwidth of 500 MHz or higher can be used, and thus shorter pulses can be generated, which makes it possible to calculate a more accurate distance based on the arrival time of the radio waves.

### Second Embodiment

A communication system 1 according to a second embodiment differs from the communication system 1 according to the first embodiment in that only mobile communication devices are used for the communication devices. The following will describe the differences from the communication system 1 according to the first embodiment.

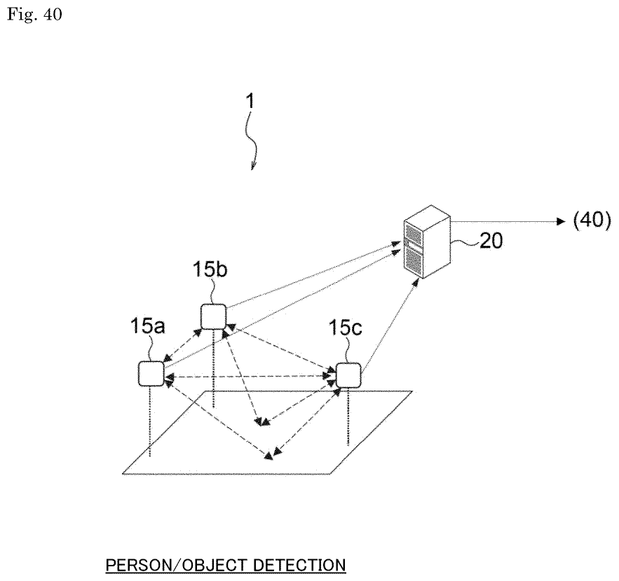

FIG. 40 is a diagram illustrating an example of the configuration of the communication system 1 when detecting an intrusion according to a second embodiment. As illustrated in FIG. 40, when detecting the intrusion of an object, an animal, or the like, in the communication system 1, the processing device 20 detects the intrusion of a person, an object, an animal, or the like based on fluctuations in the levels of the communication radio waves among the devices 15a to 15c, which are mobile communication devices. Because the devices 15a to 15c are mobile communication devices, users can place the devices 15a to 15c more freely. As described above, the devices 15a to 15c can be monitored as long as there are at least two devices.

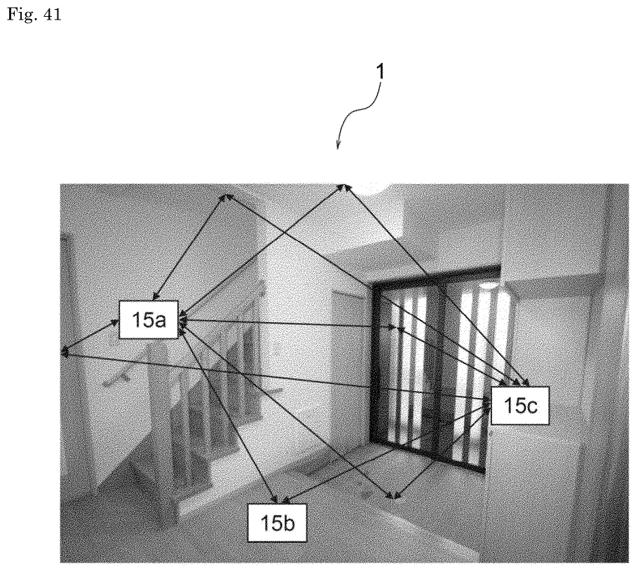

FIG. 41 is a diagram schematically illustrating an example of the deployment of the communication system 1 illustrated in FIG. 40. This figure illustrates an example of monitoring for the intrusion of a suspicious person at the entrance of a private house, for example. In this manner, with the communication system 1 according to the present embodiment, it is possible to freely set a monitoring area simply by, for example, placing the devices 15a to 15c, which are mobile communication devices.

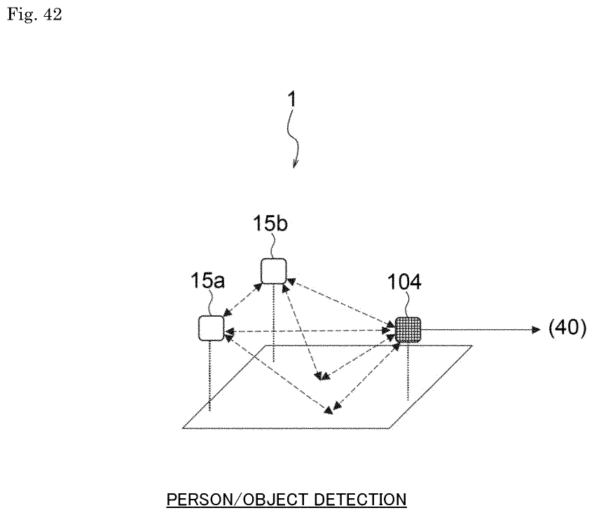

FIG. 42 is a diagram illustrating another example of the configuration of the communication system 1 when detecting an intrusion according to the second embodiment. The communication device 104 (see FIG. 33) is used for the mobile communication devices. As a result, the processing device 20 is also unnecessary.

As described above, according to the present embodiment, a mobile communication device is used for the communication device when detecting an intrusion, and thus the monitoring area can be set simply by installing the mobile communication devices. This makes it possible to configure the communication system 1 that detects an intrusion if, for example, there are two mobile communication devices used as normal telephones or the like.

### Third Embodiment

A communication system 1 according to a variation on a third embodiment differs from the communication system 1 according to the first embodiment in that positioning is started if, after an intrusion is detected, the intruder is the holder of a measurement target terminal. The following will describe the differences from the communication system 1 according to the first embodiment.

FIG. 43 is a diagram illustrating an example of the configuration of the communication system 1 according to the third embodiment. As illustrated in FIG. 43, when detecting the intrusion of an object, an animal, or the like, in the communication system 1, the processing device 20 detects the presence of a person based on fluctuations in the levels of the communication radio waves among the devices 10a to 10c, which are beacon devices. For example, the processing device 20 determines whether a specific area, such as a restroom, a conference room, or the like, is being used in response to a person/object being detected by the devices 10a to 10c. While the presence of a person is detected, the processing device 20 notifies a device dev, such as a mobile terminal, a personal computer, or the like, of the alarm signal including information indicating that a person is present in a specific area (a restroom, a conference room, or the like) over a network or the like, such that the user can refer thereto. Then, when the presence of a person is detected, if a measurement target terminal 15 is present in the monitoring area, the processing device 20 measures the position of the measurement target terminal 15 based on the distance information of the devices 10a to 10c and the device 15, notifies the device dev of the position information in the specific area (a restroom, a conference room, or the like) over the network or the like, and enables the user to refer thereto.

As described above, according to the present embodiment, during the period when a person/object is detected by the devices 10a to 10c, the processing device 20 notifies a device dev, such as a mobile terminal, a personal computer, or the like, of an alarm signal including information indicating that a person is present in a specific area (a restroom, a conference room, or the like) over a network or the like. This makes it possible for a user of the communication system 1 to ascertain the usage state of the specific area (a restroom, a conference room, or the like). In addition, when the presence of a person is detected, if the measurement target terminal 15 is present in the monitoring area, the position of the measurement target terminal 15 is measured, and the device dev is notified of the position information in the specific area (a restroom, a conference room, or the like) over the network or the like. This makes it possible for a user of the communication system 1 to ascertain the state within the specific area (a restroom, a conference room, or the like).

### Fourth Embodiment

A communication system 1 according to a variation on a fourth embodiment differs from the communication system 1 according to the first embodiment in that information on radio wave conditions among devices is used during positioning. The following will describe the differences from the communication system 1 according to the first embodiment.

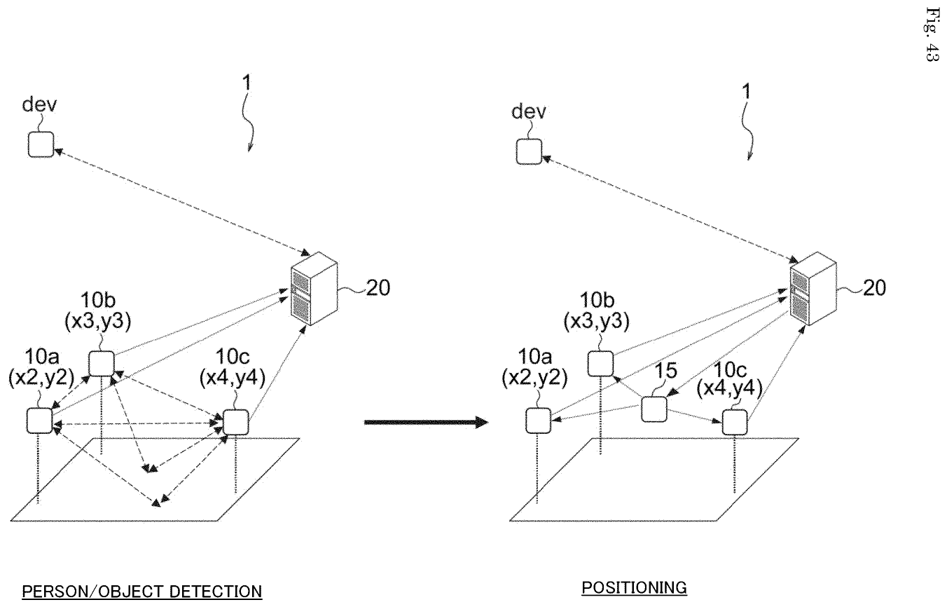

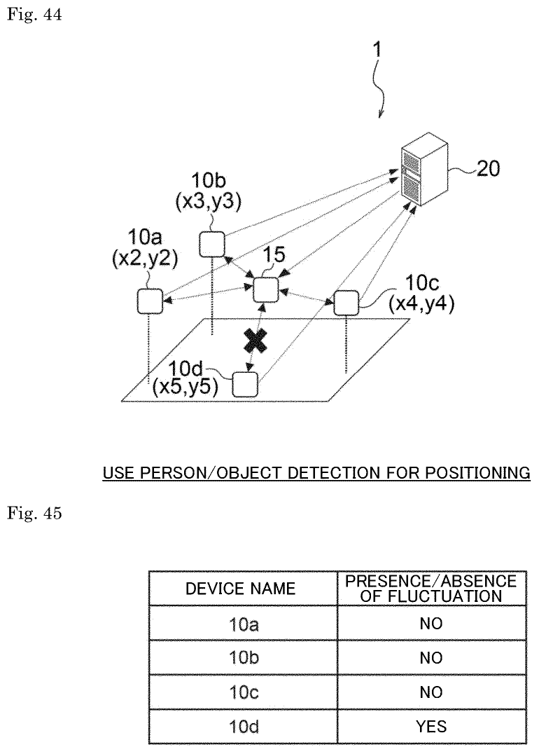

FIG. 44 is a diagram illustrating an example of the configuration of the communication system 1 according to the fourth embodiment. As illustrated in FIG. 44, the processing device 20 performs positioning of a measurement target terminal 15 using distance information from devices 10a to 10d, which are beacon devices. At this time, the position measuring unit 74 (see FIG. 13) of the processing device 20 refers to the information of the computation processing unit 84 see FIG. 13). The “x” mark schematically indicates that there are fluctuations in the response levels of the radio waves among the devices.

FIG. 45 is a table illustrating an example in which information from the computation processing unit 84 (see FIG. 13) is stored in the first storage unit 72 in association with the devices 10a to 10d. As illustrated in FIG. 45, there is a fluctuation in the radio wave response level between the device 10d and the measurement target terminal 15, and thus the position measuring unit 74 (see FIG. 13) performs the positioning without using the distance information between the device 10d and the measurement target terminal 15. As a result, the distance information for a case where there is a person, an object, or the like between the devices 10a to 10d and the measurement target terminal 15 is not used, which further improves the accuracy of the positioning of the measurement target terminal 15.

FIG. 46 is a diagram illustrating another example of the configuration of the communication system 1 according to the fourth embodiment. As illustrated in FIG. 46, the person/object detection is performed by the communication device 104 (see FIG. 33), which is a beacon device. On the other hand, the positioning of the measurement target terminal 15 is performed by the processing device 20. The position measuring unit 74 (see FIG. 13) of the processing device 20 can perform the positioning with reference to the information of the computation processing unit 84 (see FIG. 13) of the communication device 104 (see FIG. 30). The distance information for a case where there is an intruder or the like between the devices 10a to 10d and the measurement target terminal 15 is not used, which further improves the accuracy of the positioning of the measurement target terminal 15.

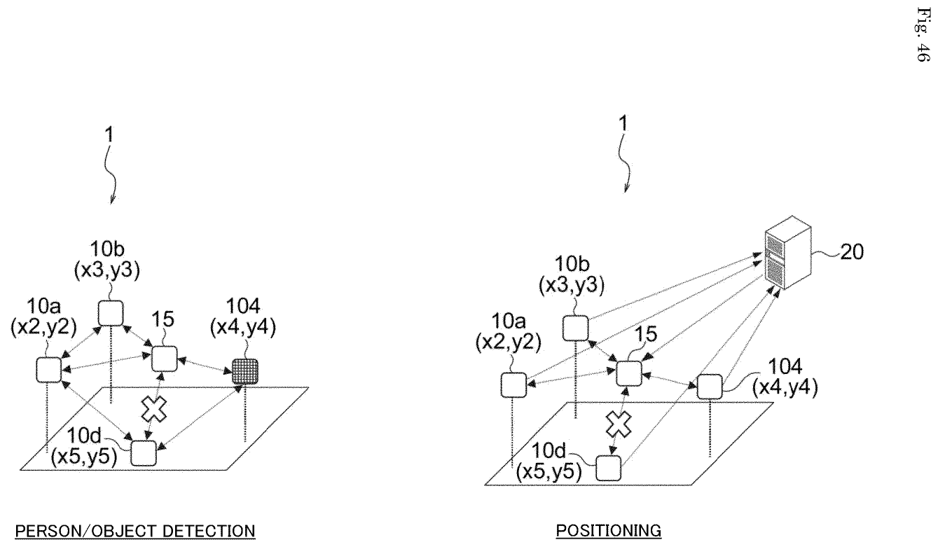

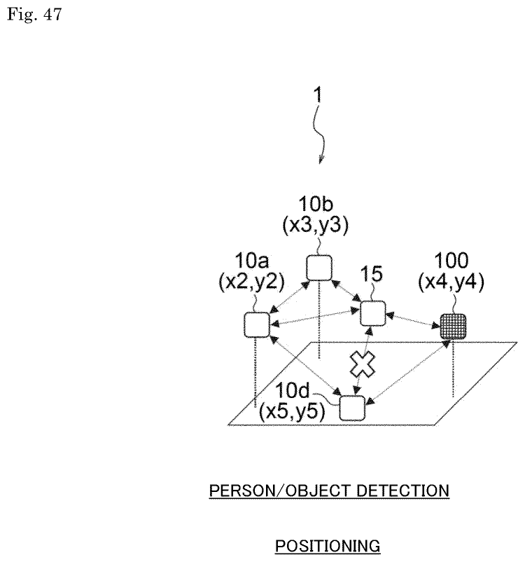

FIG. 47 is a diagram illustrating yet another example of the configuration of the communication system 1 according to the fourth embodiment. As illustrated in FIG. 47, the person/object detection and positioning are performed by the communication device 100 (see FIG. 30), which is a beacon device. The communication device 100 (see FIG. 30) performs positioning of the measurement target terminal 15 using distance information from the devices 10a to 10c and 10d, which are beacon devices, and the communication device 100. At this time, the position measuring unit 74 (see FIG. 13) of the communication device 100 refers to the information of the computation processing unit 84 see FIG. 13). As a result, the distance information for a case where there is an intruder or the like between the devices 10a to 10d and the measurement target terminal 15 is not used, which further improves the accuracy of the positioning of the measurement target terminal 15.

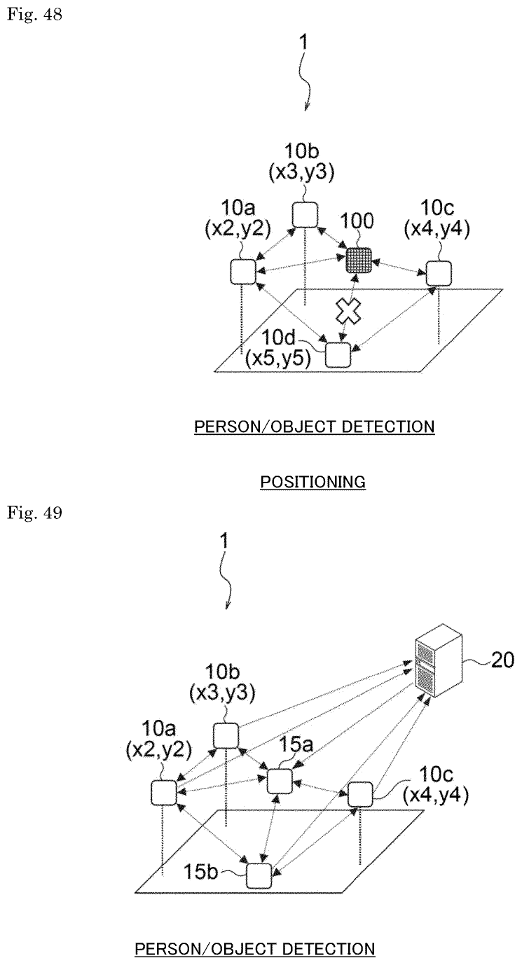

FIG. 48 is a diagram illustrating an example in which the communication device 100 of FIG. 47 is configured as a mobile terminal device. As illustrated in FIG. 48, the person/object detection and positioning are performed by the communication device 100 (see FIG. 30), which is a mobile terminal device. The communication device 100 (see FIG. 30) performs positioning of the measurement target terminal 15 using distance information from the devices 10a to 10c and 10d, which are beacon devices, and the communication device 100.

As described above, according to the present embodiment, when the position measuring unit 74 (see FIG. 13) performs the positioning, the distance information for a case where a person, an object, or the like is detected as being present between the unit and the measurement target terminal using the information on the radio wave conditions among the devices is not used, which further improves the accuracy of the positioning of the measurement target terminals.

### Fifth Embodiment

A communication system 1 according to a variation on a fifth embodiment differs from the communication system 1 according to the first embodiment in that radio wave measurements are taken by a beacon device and a mobile terminal device when a person/object is detected. The following will describe the differences from the communication system 1 according to the first embodiment.

FIG. 49 is a diagram illustrating an example of the configuration of the communication system 1 according to the fifth embodiment. As illustrated in FIG. 49, the processing device 20 performs object detection using the devices 10a to 10c, which are beacon devices, and the devices 15a and 15b, which are mobile terminal devices.

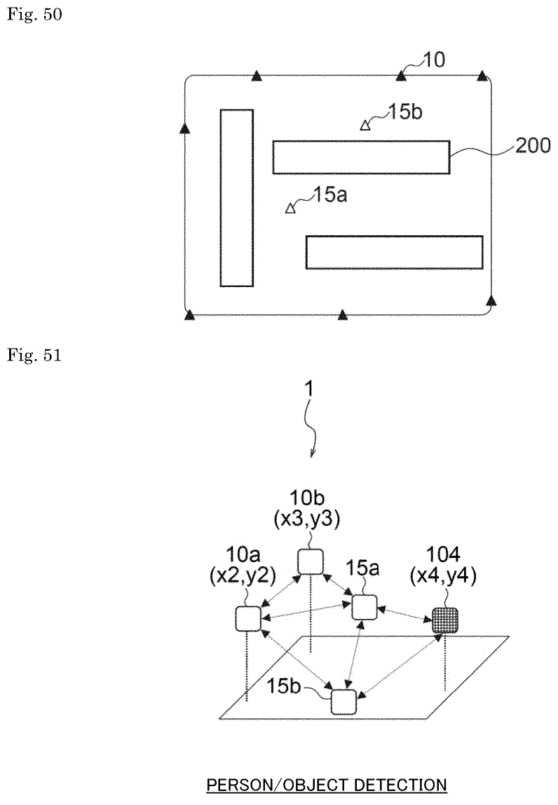

FIG. 50 is a diagram illustrating an example of the arrangement of the devices 10a to 10c, which are beacon devices, and the devices 15a and 15b, which are mobile terminal devices. For example, in an exhibition hall such as a museum, a change in the arrangement of the display shelves 200 results in an area where the radio waves of the devices 10a to 10c, which are beacon devices, do not reach. In such a case, by placing the devices 15a and 15b, which are mobile terminal devices, in the area where the radio waves do not reach, it is possible to easily eliminate the area where the radio waves do not reach.

FIG. 51 is a diagram illustrating an example of the configuration of the communication system 1 according to the fifth embodiment. As illustrated in FIG. 51, the communication device 104, which is a beacon device, performs object detection using the devices 10a and 10b and the communication device 104, which are beacon devices, and the devices 15a and 15b, which are mobile terminal devices. In addition to the processing device 20 being unnecessary, placing the devices 15a and 15b, which are mobile terminal devices, makes it possible to easily eliminate the area where radio waves do not reach.

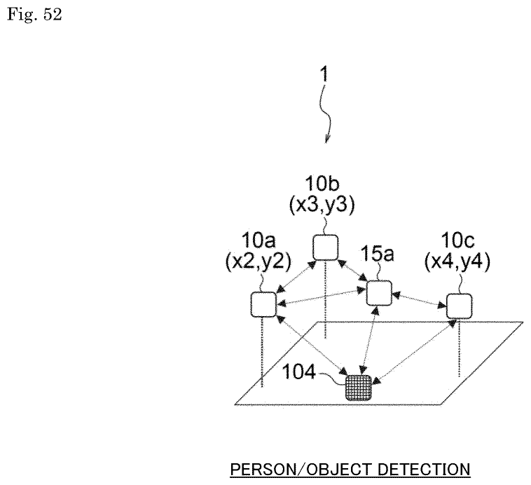

FIG. 52 is a diagram illustrating yet another example of the configuration of the communication system 1 according to the fifth embodiment. As illustrated in FIG. 52, the communication device 104, which is a mobile terminal device, performs object detection using the devices 10a to 10c, which are beacon devices, and the device 15a and the communication device 104, which are mobile terminal devices. In addition to the processing device 20 being unnecessary, placing the communication device 104, which is a mobile terminal device, makes it possible to more easily configure the communication system 1 for person/object detection.

As described above, according to the present embodiment, when detecting a person/object, radio wave measurements are taken by a beacon device and a mobile terminal device. Through this, by placing the devices which are mobile terminal devices in an area where radio waves do not reach, it is possible to easily eliminate the area where the radio waves do not reach.

Note that the present technique can also take on the following configurations.

(1) A communication processing device including:
a detection unit that, based on a propagation channel characteristic in a propagation channel between devices, detects a presence of a person/object in the propagation channel; and
an output unit that outputs a signal including information about the detection.

(2) The communication processing device according to (1),
wherein the detection unit detects the presence of the person/object in the propagation channel based on a fluctuation in a value pertaining to the propagation channel characteristic between the devices.

(3) The communication processing device according to (2),
wherein the detection unit detects the presence of the person/object in the propagation channel based on a fluctuation in a response level of a radio wave between the devices.

(4) The communication processing device according to (3), further including:
a storage unit that stores information pertaining to the response level of the radio wave in time series; and
a computation processing unit that, using the information pertaining to the response level stored in the storage unit, computes a fluctuation amount in the response level at a plurality of different times,
wherein the detection unit detects the presence of the person/object in the propagation channel based on the fluctuation amount.

(5) The communication processing device according to (1), further including:
a distance obtaining unit that obtains distance information calculated on the basis of the propagation channel characteristic.

(6) The communication processing device according to (5), further including:
a positioning unit that detects a position of a target object based on the distance information.

(7) The communication processing device according to (6),
wherein the distance obtaining unit obtains at least three instances of the distance information pertaining to a distance between the target object and each of at least three communication partner devices, and
the positioning unit detects the position of the target object based on the at least three instances of the distance information.

(8) The communication processing device according to (7), further including:
a control unit that switches between a first mode for detecting a person/object using the detection unit and a second mode for detecting the position of the target object using the positioning unit.

(9)

The communication processing device according to (8),
wherein when a person/object is detected in the first mode, the control unit detects the position of the target object using the second mode.

(10) The communication processing device according to (7),
wherein the positioning unit selects distance information to be used when detecting the position of the target object based on a radio wave characteristic between the target object and each of the communication partner device.

(11) The communication processing device according to (6), further including:
an image generation unit that generates an image associating the position detected by the positioning unit with information about a predetermined area.

(12) The communication processing device according to (11),
wherein the image generation unit generates the image associating chronological positions detected by the positioning unit with the information about the predetermined area.

(13) The communication processing device according to (11), further including:
a communication unit capable of wireless communication,
wherein the target object is a mobile terminal device capable of communication, and
the control unit causes the mobile terminal device to transmit the image through the communication unit.

(14), The communication processing device according to (1),
wherein each of the device is at least one of a mobile communication device, a beacon device, a server, or a base station that communicates wirelessly with any of the mobile communication device and the beacon device.

(15) The communication processing device according to (14),
wherein the communication processing device is at least one of a mobile communication device, a beacon device, a server, or a base station that communicates wirelessly with any of the mobile communication device and the beacon device.

(16) The communication processing device according to (5), further including: a communication unit that transmits the distance information to a processing device.

(17) The communication processing device according to (5),
wherein the distance obtaining unit obtains the distance information calculated on the basis of group delay calculated from relationships between each of frequencies and phases of a plurality of propagation channels.

(18) The communication processing device according to (5),
wherein the distance obtaining unit obtains the distance information based on a wireless signal in an Ultra Wide Band (UWB) band.

(19) The communication processing device according to (1),
wherein the detection unit detects the presence of the person/object between the devices based on information pertaining to each of frequencies and phases of a plurality of propagation channels between the devices.

(20) A communication processing method including:
detecting, based on a propagation channel characteristic in a propagation channel between devices, a presence of a person/object in the propagation channel; and
outputting a signal including information about the detection.

(21) A communication system including a plurality of devices,
wherein at least one device among the plurality of devices includes a detection unit that, based on a propagation channel characteristic in a propagation channel between devices, detects a presence of a person/object in the propagation channel.

(22) The communication system according to (21),
wherein the at least one device among the plurality of devices further includes:
a distance obtaining unit that obtains distance information calculated on the basis of the propagation channel characteristic.

(23) The communication system according to (22),
wherein the at least one device among the plurality of devices further includes:
a positioning unit that detects a position of a target object based on the distance information.

(24) The communication system according to (21),
wherein each of the plurality of devices are at least one of a mobile communication device, a beacon device, a server, or a base station that communicates wirelessly with any of the mobile communication device and the beacon device.

(25) The communication system according to (21), further including:
an alarm device that performs predetermined processing in response to a signal including information about the detection by the detection unit.

(26) The communication system according to (25),
wherein the alarm device controls any of a light source or a sound source in response to the signal.

(27) The communication system according to (21),
wherein the plurality of devices are a combination of a plurality of beacon devices and a processing device.

(28) The communication system according to (21),
wherein the plurality of devices are a combination of a plurality of mobile terminal devices and a processing device.

(29) The communication system according to (21),
wherein the plurality of devices are a combination of a beacon device, a mobile terminal device, and a processing device.

(30) The communication system according to (21),
wherein the plurality of devices are a combination of beacon devices.

(31) The communication system according to (21),
wherein the plurality of devices are a combination of mobile terminal devices.

(32) The communication system according to (21),
wherein the plurality of devices are a combination of a beacon device and a mobile terminal device.

Aspects of the present disclosure are not limited to the aforementioned individual embodiments and include various modifications that those skilled in the art can achieve, and the effects of the present disclosure are also not limited to the details described above. In other words, various additions, modifications, and partial deletions can be made without departing from the conceptual ideas and spirit of the present disclosure that can be derived from the details defined in the claims and the equivalents thereof.

### REFERENCE SIGNS LIST

1 Communication system
2 Antenna
3 Transmitting unit
4 Receiving unit
5 Distance obtaining unit
10 Beacon device
10a-10d Beacon device
15 Mobile terminal device
15a-15d Mobile terminal device
20 Processing device
40 Alarm device
70 Positioning unit
82 Second storage unit
84 Computation processing unit
86 Detection unit
88 Second output unit
100 Control unit

1. A communication processing device comprising:
a detection unit that, based on a propagation channel characteristic in a propagation channel between devices, detects a presence of a person/object in the propagation channel; and
an output unit that outputs a signal including information about the detection.

2. The communication processing device according to claim 1,
wherein the detection unit detects the presence of the person/object in the propagation channel based on a fluctuation in a value pertaining to the propagation channel characteristic between the devices.

3. The communication processing device according to claim 2,
wherein the detection unit detects the presence of the person/object in the propagation channel based on a fluctuation in a response level of a radio wave between the devices.

4. The communication processing device according to claim 3, further comprising:
a storage unit that stores information pertaining to the response level of the radio wave in time series; and
a computation processing unit that, using the information pertaining to the response level stored in the storage unit, computes a fluctuation amount in the response level at a plurality of different times,
wherein the detection unit detects the presence of the person/object in the propagation channel based on the fluctuation amount.

5. The communication processing device according to claim 1, further comprising:
a distance obtaining unit that obtains distance information calculated on the basis of the propagation channel characteristic.

6. The communication processing device according to claim 5, further comprising:
a positioning unit that detects a position of a target object based on the distance information.

7. The communication processing device according to claim 6,
wherein the distance obtaining unit obtains at least three instances of the distance information pertaining to a distance between the target object and each of at least three communication partner devices, and
the positioning unit detects the position of the target object based on the at least three instances of the distance information.

8. The communication processing device according to claim 7, further comprising:
a control unit that switches between a first mode for detecting a person/object using the detection unit and a second mode for detecting the position of the target object using the positioning unit.

9. The communication processing device according to claim 8,
wherein when a person/object is detected in the first mode, the control unit detects the position of the target object using the second mode.

10. The communication processing device according to claim 7,
wherein the positioning unit selects distance information to be used when detecting the position of the target object based on a radio wave characteristic between the target object and each of the communication partner device.

11. The communication processing device according to claim 6, further comprising:
an image generation unit that generates an image associating the position detected by the positioning unit with information about a predetermined area.

12. The communication processing device according to claim 11,
wherein the image generation unit generates the image associating chronological positions detected by the positioning unit with the information about the predetermined area.

13. The communication processing device according to claim 11, further comprising:
a communication unit capable of wireless communication,
wherein the target object is a mobile terminal device capable of communication, and
the control unit causes the mobile terminal device to transmit the image through the communication unit.

14. The communication processing device according to claim 1,
wherein each of the device is at least one of a mobile communication device, a beacon device, a server, or a base station that communicates wirelessly with any of the mobile communication device and the beacon device.

15. The communication processing device according to claim 14,
wherein the communication processing device is at least one of a mobile communication device, a beacon device, a server, or a base station that communicates wirelessly with any of the mobile communication device and the beacon device.

16. The communication processing device according to claim 5, further comprising:
a communication unit that transmits the distance information to a processing device.

17. The communication processing device according to claim 5,
wherein the distance obtaining unit obtains the distance information calculated on the basis of group delay calculated from relationships between each of frequencies and phases of a plurality of propagation channels.

18. The communication processing device according to claim 1,
wherein the detection unit detects the presence of the person/object between the devices based on information pertaining to each of frequencies and phases of a plurality of propagation channels between the devices.

19. A communication processing method comprising:
detecting, based on a propagation channel characteristic in a propagation channel between devices, a presence of a person/object in the propagation channel; and
outputting a signal including information about the detection.

20. A communication system comprising a plurality of devices,
wherein at least one device among the plurality of devices includes a detection unit that, based on a propagation channel characteristic in a propagation channel between devices, detects a presence of a person/object in the propagation channel.
